(19) United States
(12) Patent Application Publication
(10) Pub. No.: US 2021/0173667 A1
(43) Pub. Date: Jun. 10, 2021

(54) Electronic Device Configuration Tool and Corresponding Methods

(71) Applicant: Motorola Mobility LLC, Chicago, IL (US)

(72) Inventors: Rachid Alameh, Crystal Lake, IL (US); John Gorsica, Round Lake, IL (US)

(21) Appl. No.: 16/703,670

(22) Filed: Dec. 4, 2019

(51) Int. Cl. G06F 9/4401; G06F 9/445; G06F 21/32; G06F 21/83

(52) U.S. Cl. CPC G06F 9/4411; G06F 21/83; G06F 21/32; G06F 9/44505

(57) ABSTRACT

An electronic device configuration tool includes a communication interface, one or more processors, and an encrypted memory storing a plurality of user preferred electronic device settings associated with a plurality of electronic device types. The one or more processors detect the communication interface establishing electronic communication with another electronic device, identify an electronic device type of the other electronic device, and select one or more user preferred electronic device settings applicable to the electronic device type of the other electronic device. The one or more processors then automatically configure the other electronic device with the one or more user preferred electronic device settings by delivering one or more electronic device configuration signals to the other electronic device.

### BACKGROUND

### Technical Field

This disclosure relates generally to electronic devices, and more particularly to electronic devices having data communication capabilities.

### Background Art

Modern electronic devices such as laptop computers, smartphones, tablet computers, and smart watches, are configurable in that a user can select what applications to run on the device, what data should be stored on the device, how information should be presented on the device, how information should be shared with other devices, and so forth. Since the ways in which such devices can be configured borders on the infinite, manually configuring a device as desired is a time consuming process. It would be advantageous to have devices and methods offering a more streamlined and efficient personal configuration process for electronic devices.

### BRIEF DESCRIPTION OF THE DRAWINGS

FIG. 1 illustrates one explanatory method in accordance with one or more embodiments of the disclosure.

FIG. 2 illustrates another explanatory method in accordance with one or more embodiments of the disclosure.

FIG. 3 illustrates various explanatory electronic devices in accordance with one or more embodiments of the disclosure.

FIG. 4 illustrates one explanatory electronic device configuration tool in accordance with one or more embodiments of the disclosure.

FIG. 5 illustrates another explanatory method in accordance with one or more embodiments of the disclosure.

FIG. 6 illustrates one explanatory system, method, and signal flow diagram in accordance with one or more embodiments of the disclosure.

FIG. 7 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to identifying an electronic device type after establishing an electronic communication channel between the electronic device and an electronic device configuration tool, selecting one or more user preferred electronic device settings applicable to the electronic device type, and automatically configuring the other electronic device with the one or more user preferred electronic device settings by delivering one or more electronic device configuration signals to the other electronic device. Any process descriptions or blocks in flow charts should be understood as representing modules, segments, or portions of code that include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of detecting, with one or more processors of an electronic device configuration tool, establishment of electronic communication with another electronic device, identifying, with an authentication device, whether authentication data received by the authentication device belongs to an authorized user of the electronic device configuration tool, determining what type of electronic device the other electronic device is, selecting one or more user preferred electronic device settings, and delivering them to the other electronic device to configure the other electronic device, as described herein. The non-processor circuits may include, but are not limited to, a radio receiver, a radio transmitter, signal drivers, clock circuits, power source circuits, and user input devices. As such, these functions may be interpreted as steps of a method to perform the detection of the establishment of an electronic communication channel and automatically configuring another electronic device with one or more user preferred electronic device settings automatically.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially”, “essentially”, “approximately”, “about” or any other version thereof, are defined as being close to as understood by one of ordinary skill in the art, and in one non-limiting embodiment the term is defined to be within ten percent, in another embodiment within five percent, in another embodiment within one percent and in another embodiment within 0.5 percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide devices, methods, and systems that allow a person to pick up a new or otherwise unconfigured electronic device, such as a smartphone, tablet computer, laptop computer, or other electronic device, and have it instantly and automatically be configured with all of their information, settings, applications, files, pictures, songs, font size preferences, and other configuration preferences. Illustrating by example, whenever a person gets a new electronic device, be it a smartphone, smart speaker, smart television, or other device, they have to perform numerous manual and tedious steps to set the new device up with their preferences. These steps can include entering an local area network access point name and password, entering user credentials to access cloud-based services, downloading applications, uploading data, configuring the user interface with preferred colors, fonts, font sizes, viewing preferences, and power modes of operation, just to name a few of the configuration steps that must be performed. All of this is tedious work and makes setting up a new device painful.

Embodiments of the disclosure provide solutions to this problem. Rather than having to manually configure a new device, embodiments of the disclosure provide an electronic device configuration tool that includes a communication interface, one or more processors electrically in communication with the communication interface, and an encrypted memory operable with the one or more processors. In one or more embodiments, the encrypted memory stores a plurality of user preferred electronic device settings associated with a plurality of electronic device types.

In one or more embodiments, the one or more processors detect when the communication interface establishes electronic communication with another electronic device. In one or more embodiments, a device includes a communication interface, which can be a physical communication interface such as a connector, or alternatively a wireless communication interface. The one or more processors then identify an electronic device type of the other electronic device from signals received from the other electronic device through the communication interface. The one or more processors then select one or more user preferred electronic device settings applicable to the electronic device type of the other electronic device from the plurality of user preferred electronic device settings as a function of the electronic device type. Thereafter, the one or more processors then automatically configure the other electronic device with the one or more user preferred electronic device settings by delivering one or more electronic device configuration signals to the other electronic device.

In one or more embodiments, the electronic device configuration tool is configured as a small fob that stores all of the user's settings and preferences for every other device type in the encrypted memory. This fob-style electronic device configuration tool can then be coupled to another electronic device with a connector to establish the electronic communication with the other electronic device, or alternatively may communicate wirelessly to establish the electronic communication with the other electronic device. In one or more embodiments, a device includes a communication interface, which can be a physical communication interface such as a connector, or alternatively a wireless communication interface.

In one or more embodiments, the electronic device configuration tool includes an authentication device that can authenticate a person as an authorized user of the electronic device configuration tool. Illustrating by example, a fingerprint sensor, keypad, imager, depth sensor, or other authentication device, can be operable with the one or more processors to determine whether authentication data, such as fingerprint data, facial recognition data, a password, or a personal identification number (PIN) was received from, or belongs to, an authorized user of the electronic device configuration tool. Accordingly, the electronic device configuration tool can authenticate the user as an authorized user to prevent unauthorized users from using the electronic device configuration tool.

In one or more embodiments, once electronic communication has been established with another electronic device, and a person has been authenticated as an authorized user of the electronic device configuration tool, the one or more processors of the electronic device configuration tool then deliver electronic signals to the communication interface comprising the user preferred settings and preferences to automatically configure the other electronic device and/or create a new user profile for the authorized user in the other electronic device. In one or more embodiments, the one or more processors of the electronic device configuration tool deliver signals comprising all of the authorized user's settings and preferences applicable to the device type of the other electronic device.

In one or more embodiments, the electronic device configuration tool does not need to remain in communication with the other electronic device for the other electronic device to use the user preferred settings of the authorized user. Instead, in one or more embodiments the authorized user can then remove the electronic device configuration tool from the other electronic device, thereby terminating the electronic communication with the other electronic device. The other electronic device would then continue to operate normally using all of the authorized user's settings and preferences applicable to the device type of the other electronic device. Since the encrypted memory of the electronic device configuration tool stores a plurality of user preferred electronic device settings applicable to a variety of electronic devices, in one or more embodiments the authorized user can use the electronic device configuration tool to repeat the process with a variety of device types, thereby streamlining the setup process for each electronic device.

In one or more embodiments, the electronic device configuration tool includes an authentication device. In one or more embodiments, the electronic device configuration tool authenticates a person as an authorized user of the electronic device configuration tool prior to transferring all of the authorized user's settings and preferences applicable to the device type of the other electronic device. This can be done in a variety of ways. Illustrating by example, in one or more embodiments the electronic device configuration tool includes a fingerprint sensor that receives fingerprint data and compares it to one or more authentication references stored in the encrypted memory to determine if it sufficiently matches so as to authenticate the person as an authorized user of the electronic device configuration tool. Other types of authentication devices can be used as well, including voice recognition, facial recognition, entry of a password or personal identification number, or by other techniques. If the authentication device is a fingerprint sensor, this can comprise receiving fingerprint data at the fingerprint sensor. If the authentication device is a depth imager, this can comprise receiving a facial depth scan of a person with the depth imager. If the authentication device is a keypad, this can comprise receiving a personal identification number (PIN), and so forth.

The user preferred electronic device settings can include a variety of settings, files, data, preferences, and more. For instance, in one or more embodiments the one or more processors of the electronic device configuration tool can transmit user settings and preferences to the other electronic device, an application list for installing on the other electronic device, user subscriber identification module (SIM) data for provisioning an embedded subscriber identification module (eSIM) of the other electronic device, user credentials to create login events to access information, data, and settings from online applications and/or cloud-based services, and biometric information for later enabling the other electronic device to authenticate the authorized user.

In one or more embodiments, after the other electronic device has been used for some period of time, embodiments of the disclosure contemplate that the user may have altered or adjusted the various user preferred electronic device settings. Accordingly, the settings and preferences on the other electronic device may no longer match the data stored in the encrypted memory of the electronic device configuration tool. To correct this discrepancy, in one or more embodiments the authorized user can again establish electronic communication between the electronic device configuration tool and the other electronic device. As before, this can comprise coupling a connector of the electronic device configuration tool, such as a universal serial bus connector, secure data (SD) card connector, serial peripheral interface (SPI) connector, inter-integrated circuit (I2C) connector, universal asynchronous receiver-transmitter (UART) connector, to the other electronic device, or alternatively establishing a wireless communication channel, such as with a near-field connector (NFC) device, wireless fidelity (Wi-Fi), or BlueTooth, with the other electronic device. In one or more embodiments, the authentication device of the electronic device configuration tool could then reauthenticate the user as the authorized user of the electronic device configuration tool. Once this occurs, new settings from the other electronic device could be downloaded to the encrypted memory of the electronic device configuration tool, optionally replacing or updating the current settings stored in the encrypted memory. In one or more embodiments, the user may need to be prompted during this backup process to confirm the desired behavior used to resolve any conflicts.

Advantageously, embodiments of the disclosure store, in an encrypted memory of an electronic device configuration tool, a super-set of multiple device settings. In one or more embodiments, an authentication device of the electronic device configuration tool can authenticate a person as an authorized user of the electronic device configuration tool for the purpose of setting up another electronic device in a seamless way. Moreover, in one or more embodiments the electronic device configuration tool can update the super-set of multiple device settings in the encrypted memory by establishing communication between the electronic device configuration tool and the other electronic device and prompting the user to confirm changes to the data.

In one or more embodiments, the encrypted memory of the electronic device configuration tool stores one or more user-preferred settings for one or more functions of the other electronic device. For example, the encrypted memory of the electronic device configuration tool can store data, information, and preferences that the other electronic device can load. Additionally, the encrypted memory can store files, preferences, and applications preferred by the user.

Other data can be stored in the encrypted memory as well. For instance, in one or more embodiments the encrypted memory comprises virtual private network communication preferences and credentials for communication with other electronic devices across a network. The encrypted memory could store user preference information such as ringtone preferences, font size preferences, screen brightness preferences, audio setting preferences, call handling preferences, data handling preferences, application suite preferences, or other information. The encrypted memory could store preferred electronic devices to connect to, preferred power modes of operation, preferred authenticating technologies, preferred presence scanning duty cycles, preferred methods of connection, and so forth.

The encrypted memory could also store subscriber identification module information that allows the other electronic device to transmit and receive voice calls, transmit and receive text messages, and otherwise use data from a subscription plan purchased by the authorized user of the electronic device configuration tool. The encrypted memory could also store credentials to access services in the “cloud.” For example, the credentials stored in the encrypted memory could allow the other electronic device to access to accounts, application, data, and services stored on a remote server across a network in one or more embodiments. These examples of what can be stored in the encrypted memory are illustrative only. Numerous others will be obvious to those of ordinary skill in the art having the benefit of this disclosure.

In one or more embodiments, establishing electronic communication between the electronic device configuration tool and another electronic device automatically configures the other electronic device as desired by an authorized user in a seamless and effortless manner. In one or more embodiments, upon authenticating the user, the electronic device configuration tool enables communication of user information, user settings, user applications and application suites, device settings, and so forth to configure the other electronic device with a predefined user-preferred configuration. In one embodiment, this exchange of one or more user-preferred settings occurs without any additional input from the person coupling the electronic device configuration tool to the other electronic device. In this manner, the communication between the electronic device configuration tool and the other electronic device to configure the other electronic device appears seamless and instant. To the user, “it just works.”

Thus, embodiments of the disclosure provide an electronic device configuration tool that stores user preferred settings, data, files, preferences, applications, application suites, and so forth for use in configuring other electronic devices as desired by an authorized user of the electronic device configuration tool. In one or more embodiments, these one or more user preferred settings are protected by an authentication device, which could be a fingerprint sensor, other biometric sensor, keypad, or other device. Upon an authorized user delivering authorization data to the authorization device, e.g., delivering fingerprint data to a fingerprint sensor, and upon the one or more processors of the electronic device configuration tool establishing electronic communication with another electronic device, such as by physically connecting a connector of a physical interface or placing the electronic device configuration tool close enough for a wireless communication interface to establish communication with the other electronic device, the user preferred settings, data, files, preferences, applications, application suites, and so forth are unlocked and delivered to the other electronic device. At a later time, in one or more embodiments the one or more processors of the electronic device configuration tool copy any alterations to the user preferred settings, data, files, preferences, applications, application suites, and so forth back to the encrypted memory of the electronic device configuration tool.

In addition to the user preferred settings, data, files, preferences, applications, and application suites, other information can be stored in the encrypted memory of the electronic device configuration tool as well. For instance, application preferences and context, such as bookmarks and open tabs in a browser, device settings such as preferred fonts, preferred font size, ringtone preferences, audio setting preferences, call handling preferences, data preferences, screen brightness preferences, and so forth can be stored in the encrypted memory as well. All of this information can be loaded onto another electronic device to configure the other electronic device when the electronic device configuration tool establishes electronic communication with the other electronic device and the authentication device identifies authenticates authentication data as belonging to the authorized user of the electronic device configuration tool.

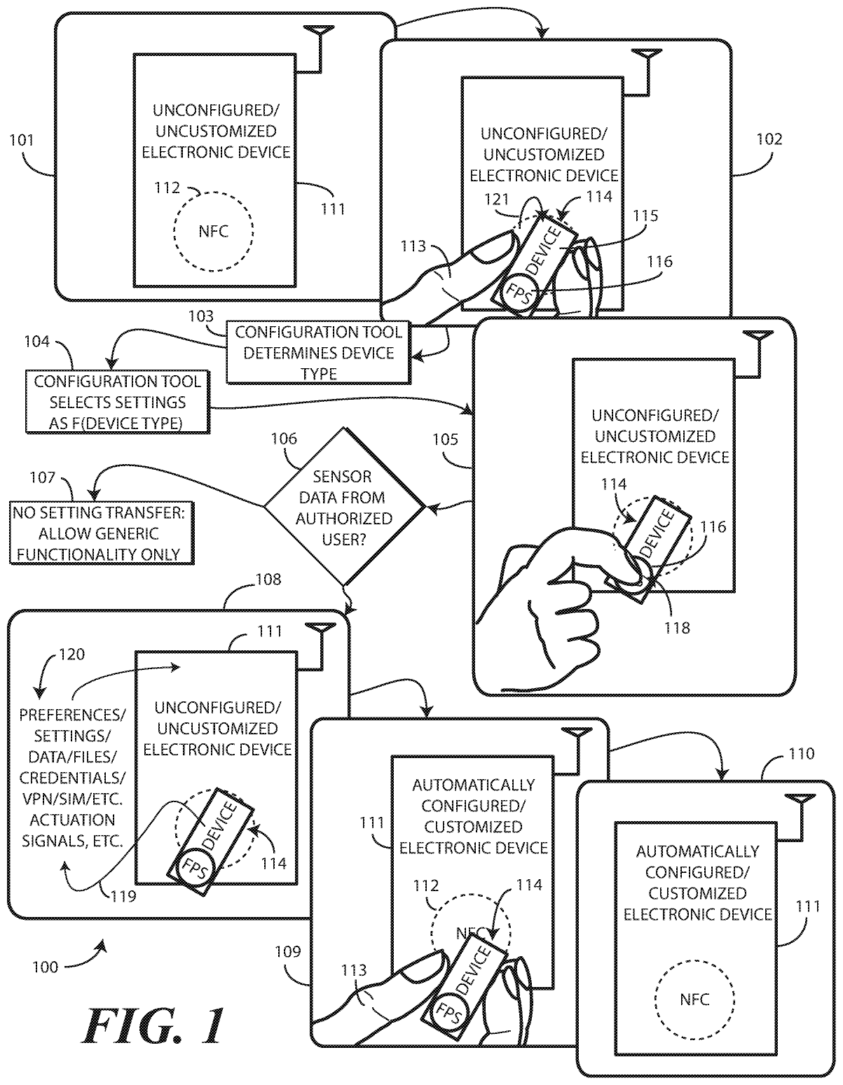

Turning now to FIG. 1, illustrated therein is one explanatory method 100 in accordance with one or more embodiments of the disclosure. Beginning at step 101, an electronic device 111, shown illustratively as a smartphone, is initially in an unconfigured and/or uncustomized state. While shown illustratively as a smartphone, it should be noted that the electronic device 111 could be any number of electronic devices, including a laptop computer, a tablet computer, a desktop computer, a gaming device, a voice assistant device, a smart television, an Internet-of-Things (IoT) device, or other type of electronic device. Other examples of electronic devices suitable for use with embodiments of the disclosure will be obvious to those of ordinary skill in the art having the benefit of this disclosure. The electronic device 111 may be in the unconfigured and/or uncustomized state, for example, if it is a new device having been shipped from the factory with only generic functions and applications loaded and operable on the electronic device 111.

When in the unconfigured and/or uncustomized state, generic functions such as telephone applications, text messaging applications, web browsing applications, and so forth may be fully operational. However, they are considered to be “unconfigured” or “uncustomized” due to the fact that user preferences, such as a particular person's preferred contact list of numbers for the telephone application, a particular person's history of exchanged text messages for the text messaging application, or a particular person's browsing history, bookmark, and open tabs for the web browsing application are not available or accessible by any of these applications. Thus, a user using a generic function may be able to navigate to a particular website, e.g., the home page of Buster's Bluesmen with their new album, Mac's Boogie Woogie. However, to do so they would need to either know the uniform resource locator (URL) of Buster's page, or else find it in a search engine due to the fact that no bookmarks are stored in the web browsing application in its generic state.

In one or more embodiments, the electronic device 111 includes a communication interface 112 with which it can communicate with an electronic device configuration tool. In the illustrative embodiment of FIG. 1, the communication interface 112 comprises a wireless communication interface without a physical connector. In this illustrative embodiment, the communication interface 112 is configured as a near-field communication interface. However, where the communication interface 112 is configured as a wireless communication interface, it can be configured to communicate with other wireless protocols. For example, the communication interface 112 can be configured as a Wi-Fi interface, a Bluetooth interface, or other wireless interface.

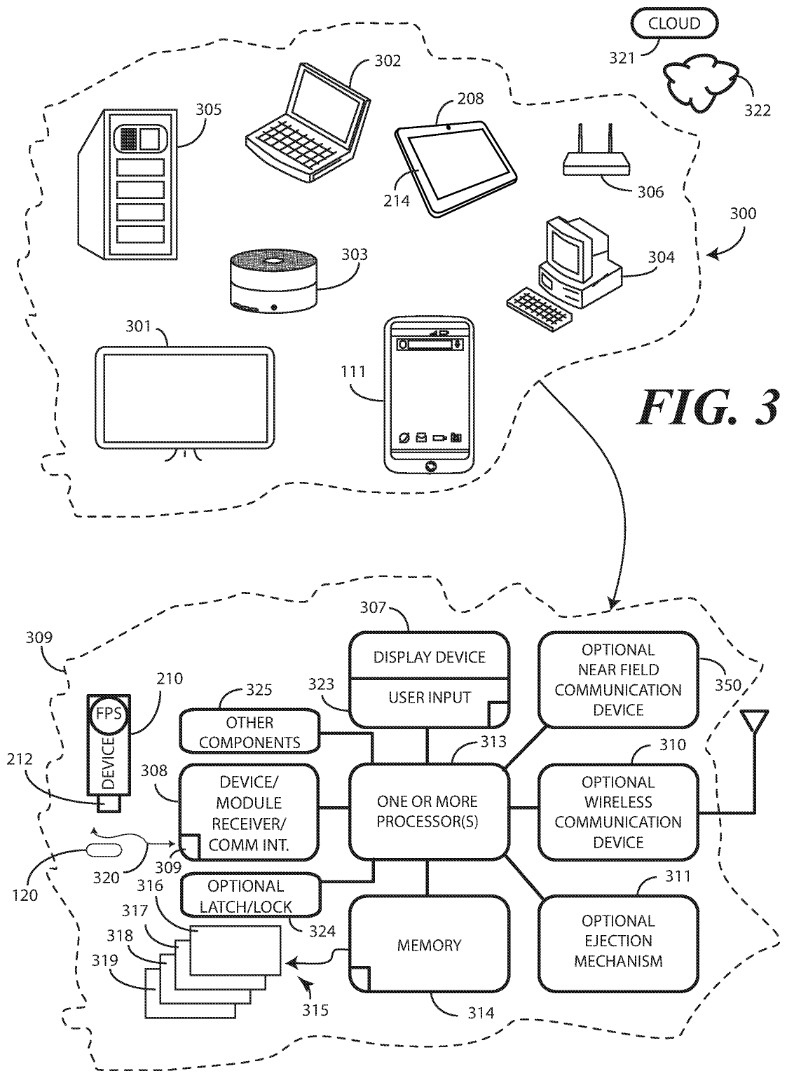

As will be described with reference to FIG. 3 below, in other embodiments the communication interface 112 can be configured as a physical interface in the form of an electronic device configuration tool receiver slot with a physical connector to which an electronic device configuration tool can be coupled. The physical connector can take a variety of forms. For example, the physical connector can be any of a universal serial bus connector, secure digital card interface, high-definition multimedia connector, serial peripheral interface (SPI) connector, inter-integrated circuit (I2C) connector, universal asynchronous receiver-transmitter (UART) connector, or other connector. Other forms of communication interfaces will be obvious to those of ordinary skill in the art having the benefit of this disclosure.

At step 102 a user 113 places an electronic device configuration tool 114 on the housing of the electronic device 111 atop the communication interface 112 of the electronic device 111. In this illustrative embodiment, the electronic device configuration tool 114 is configured as a small, handheld device that the user 113 can conveniently carry in a pocket, on a lanyard around their neck, or attached to a bracelet. In one or more embodiments, the electronic device configuration tool 114 includes a housing 115. In this illustrative embodiment, since the communication interface 112 of the electronic device 111 comprises a wireless communication interface without a connector. By exchanging wireless communication signals with the communication interface 112 of the electronic device 111, one or more processors of the electronic device configuration tool 114 can establish electronic communication 121 with the electronic device 111.

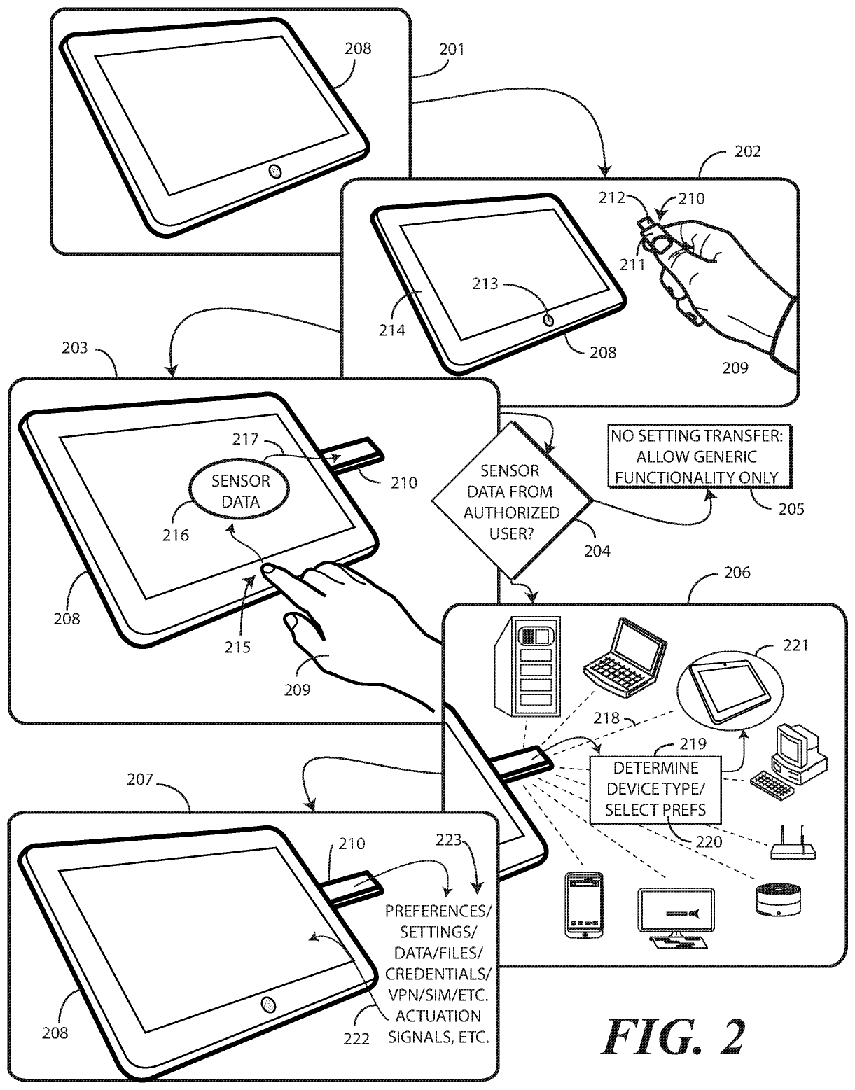

As will be shown and described below with reference to FIG. 2, in other embodiments the electronic device configuration tool 114 will comprise a connector as its communication interface. The electronic device 111 can then include a complementary connector, such as a universal serial bus connector, which serves as a communication interface for the electronic device 111. Where configured with a connector, the user 113 could establish electronic communication between the electronic device configuration tool 114 and the electronic device 111 by coupling the complementary connector of the electronic device 111 the connector of the electronic device configuration tool 114.

In one or more embodiments, the electronic device configuration tool 114 includes an authentication device 116 that is carried by the housing 115 of the electronic device configuration tool 114. In one or more embodiments, the authentication device 116 is operable with one or more processors of the electronic device configuration tool 114.

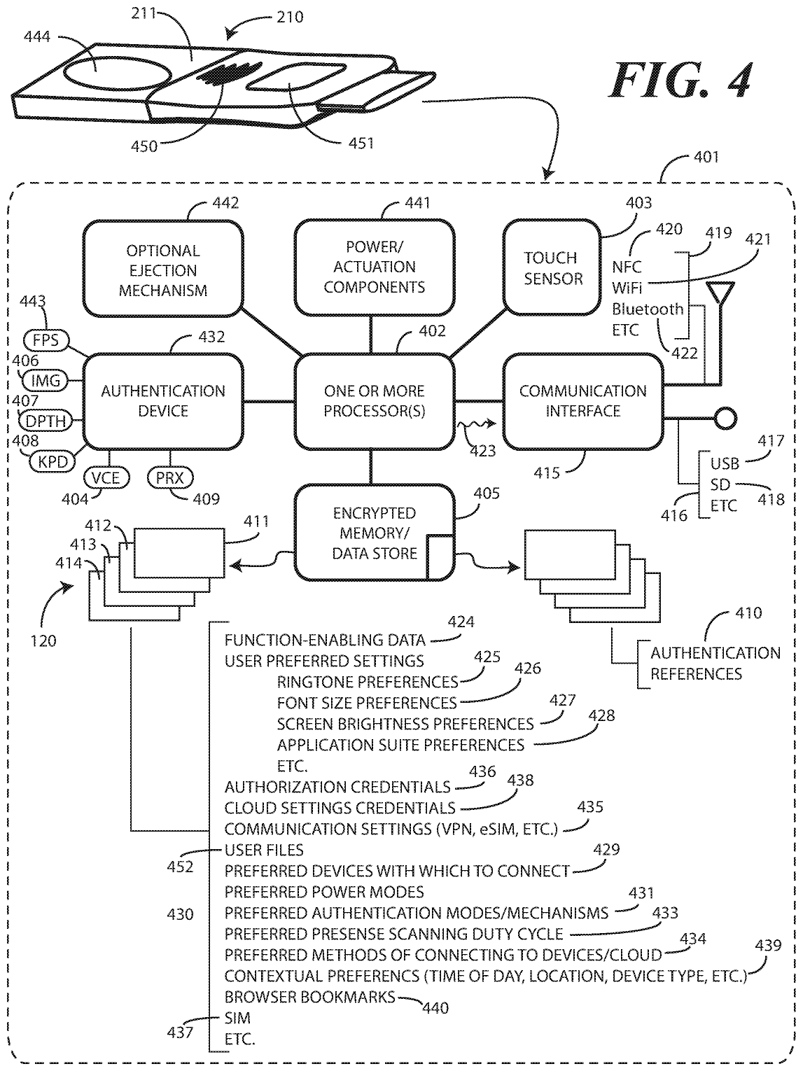

In this illustrative embodiment, the authentication device 116 comprises a fingerprint sensor. However, as will be described below with reference to FIG. 4, the authentication device 116 can take other forms as well. For example, in another embodiment the authentication device 116 can comprise an imager that performs facial recognition on the user 113. In another embodiment, the authentication device 116 comprises an audio input device that performs voice recognition on audio input received from the user 113. In still another embodiment, the authentication device 116 comprises a depth scanner that obtains a depth scan of a face of the user 113. In still other embodiments, the authentication device 116 can comprise a touchpad allowing the user 113 to enter a signature or personal identification number (PIN). As will be described below with reference to FIG. 2, in other embodiments the one or more processors of the electronic device configuration tool 114 can cause a sensor of an electronic device with which the electronic device configuration tool 114 is in electronic communication to capture authentication data. For example, in other embodiments the one or more processors of the electronic device configuration tool 114 can cause the electronic device with which it is in electronic communication to launch its camera or allow entry of a password on a touch-sensitive display, for example.

Regardless of type, in one or more embodiments the authentication device 116 is configured to process authentication data received by the authentication device 116 to determine whether the authentication data is received from, or belongs to, an authorized user of the electronic device configuration tool 114. The various authentication devices listed above are illustrative only, and can be used alone or in combination. Other examples of authentication devices will be obvious to those of ordinary skill in the art having the benefit of this disclosure.

As will also be described below with reference to FIG. 4, in one or more embodiments the electronic device configuration tool 114 comprises one or more processors and an encrypted memory operable with the one or more processors. In one or more embodiments, the one or more processors are operable with the authentication device 116 as well.

In one or more embodiments, the one or more processors of the electronic device configuration tool 114 receive power from the electronic device 111 when electronic communication 121 is established between the electronic device configuration tool 114 and the electronic device 111. Said differently, in one or more embodiments the one or more processors of the electronic device configuration tool 114 receive power from the communication interface 112 of the electronic device 111 when the communication interface of the electronic device configuration tool 114, which is wireless in this example, establishes electronic communication 121 with one or more processors of the electronic device 111. In this example, the communication interface 112 of the electronic device 111 could include a wireless charging coil to deliver power to the electronic device configuration tool 114 when the electronic device configuration tool 114 is placed atop the communication interface 112 of the electronic device 111.

Accordingly, in one or more embodiments the one or more processors of the electronic device configuration tool 114 are actuated by power received from the complementary connector upon the complementary connector establishing communication 121 with the electronic device 111 at step 102. Thus, step 102 comprises the one or more processors of the electronic device configuration tool 114 receiving power at the complementary connector that actuates the one or more processors of the electronic device configuration tool 114 in one or more embodiments.

At step 103, the one or more processors of the electronic device configuration tool 114, in response to detecting the communication interface of the electronic device configuration tool establishing electronic communication 121 with the communication interface 112 of the electronic device 111, identify an electronic device type of the electronic device 111 from signals 121 received from the electronic device 111 through the communication interface. In this example, the electronic device 111 is a smartphone. Accordingly, at step 103 the one or more processors of the electronic device configuration tool 114 determine this device type by querying the electronic device 111 and receiving signals 121 in response through the communication interface.

In one or more embodiments, the encrypted memory of the electronic device configuration tool 114 stores a plurality of user preferred electronic device settings associated with a plurality of electronic devices. For example, the encrypted memory of the electronic device configuration tool 114 could store a first set of user preferred electronic device settings for a smartphone, a second set of user preferred electronic device settings for a tablet computer, a third set of user preferred electronic device settings for a smart television, a fourth set of user preferred electronic device settings for a voice assistant, a fifth set of user preferred electronic device settings for a laptop computer, a sixth set of user preferred electronic device settings for a smart watch, a seventh set of user preferred electronic device settings for an Internet-of-Things (IoT) refrigerator, and so forth.

At step 104, the one or more processors of the electronic device configuration tool 114 select on or more user preferred electronic device settings applicable to the electronic device type identified at step 103 from the plurality of user preferred electronic device settings as a function of the electronic device type identified at step 103. In this example, the one or more processors of the electronic device configuration tool 114 would select user preferred electronic device settings applicable for a smartphone at step 104 due to the fact that the electronic device 111 was determined to be a smartphone at step 103.

At step 105, the user 113 is delivering authentication data 118 to the authentication device 116 of the electronic device configuration tool 114. Since the authentication device 116 is a fingerprint sensor in this illustrative embodiment, the authentication data 118 comprises fingerprint data, with step 105 comprising the authentication device 116 receiving authentication data in the form of fingerprint data.

At decision 106, one or more processors of the electronic device configuration tool 114 determine whether the authentication data 118 received from the user 113 at step 105 is received from an authorized user of the electronic device configuration tool 114. The one or more processors of the electronic device configuration tool 114 can compare the authentication data 118 with one or more predefined authentication references stored in the encrypted memory of the electronic device configuration tool 114 to determine whether the authentication data sufficiently matches one or more of the predefined authentication references to confirm that the authentication data 118 belongs to, or is received from, an authorized user of the electronic device configuration tool 114.

Where the one or more processors of the electronic device configuration tool 114 fail to identify the authentication data 118 as belonging to, or being received from, an authorized user of the electronic device configuration tool 114, in one or more embodiments step 107 comprises the one or more processors of the electronic device configuration tool 114 leaving the electronic device 111 in the unconfigured or uncustomized state. This results in only the generic functions of the electronic device 111 to be operable on the electronic device 111. In this condition, a person could still interact with the electronic device 111, but would be not be able to avail themselves to use, access, or see any user preferred settings, data, files, preferences, applications, application suites, and so forth of the authorized user that may be stored in the encrypted memory of the electronic device configuration tool 114. Thus, where the electronic device 111 includes one or more generic functions that are operable without access to any of the user preferred settings, data, files, preferences, applications, application suites, and so forth that may be stored in the encrypted memory of the electronic device configuration tool 114, step 107 can comprise the one or more processors of the electronic device configuration tool 114 leaving only the one or more generic functions to be operable when the authentication data 118 received at step 105 fails to identify the user 113 as being an authorized user of the electronic device configuration tool 114.

By contrast, when the one or more processors of the electronic device configuration tool 114 confirm that, at decision 106, the authentication data 118 belongs to, or is received from, an authorized user of the electronic device configuration tool 114, the method 100 moves to step 108. At step 108, the one or more processors of the electronic device configuration tool 114 automatically deliver 119, from the encrypted memory, one or more user preferred electronic device settings 120 to the communication interface, and thus to the electronic device 111.

In one or more embodiments, the user preferred electronic device settings 120 enable one or more functions of the electronic device 111. For example, the one or more user preferred electronic device settings 120 can comprise an application suite defining a plurality of applications that should be downloaded and installed on the electronic device 111. Accordingly, delivering these one or more user preferred electronic device settings 120 to the electronic device 111 would cause the application suite to be downloaded and installed, thereby enabling these new applications as new functions of the electronic device 111 at step 108.

The one or more user preferred electronic device settings 120 can comprise a variety of data suitable for configuring the electronic device 111 to the personal tastes of an authorized user of the electronic device configuration tool 114. Illustrating by example, the one or more user preferred electronic device settings 120 can comprise one or more user-preferred settings for one or more functions of the electronic device 111. This can include data and files belonging to the authorized user of the electronic device configuration tool 114, other information belonging to the authorized user of the electronic device configuration tool 114, and/or applications or an application suite preferred by the authorized user of the electronic device configuration tool 114.

The one or more user preferred electronic device settings 120 can also comprise virtual private network communication preferences and credentials with which the electronic device 111 can communicate with other electronic devices across a network. The one or more user preferred electronic device settings 120 can include additional user preference information such as ringtone preferences, font size preferences, screen brightness preferences, audio setting preferences, call handling preferences, data handling preferences, application suite preferences, or other information. The one or more user preferred electronic device settings 120 can include a list of preferred electronic devices to which the electronic device 111 can connect, preferred power modes of operation for the electronic device 111, preferred authorized user authenticating technologies that should be used by the electronic device 111, e.g., voice recognition, fingerprint sensor, facial recognition, and so forth, preferred presence scanning duty cycles to detect whether a person is still using the electronic device 111 prior to the electronic device 111 entering a low-power or sleep monde, preferred methods of connection to cloud services for the electronic device 111, and so forth.

The one or more user preferred electronic device settings 120 can also include subscriber identification module information that can be loaded into an eSIM module of the electronic device 111, thereby allowing the electronic device 111 to transmit and receive voice calls, transmit and receive text messages, and otherwise use data from a subscription plan purchased by the authorized user of the electronic device configuration tool 114. The one or more user preferred electronic device settings 120 can also comprise credentials to access services in the “cloud.” For example, the one or more user preferred electronic device settings 120 can comprise credentials to allow the electronic device 111 to access to accounts, application, data, and services stored on a remote server across a network in one or more embodiments. These examples of one or more user preferred electronic device settings 120 are illustrative only. Numerous others will be obvious to those of ordinary skill in the art having the benefit of this disclosure.

At step 109, the user 113 can remove the electronic device configuration tool 114 from the communication interface 112 of the electronic device 111, thereby interrupting any electronic communication 121 occurring between the electronic device 111 and the electronic device configuration tool 114. Embodiments of the disclosure contemplate that once the electronic device 111 has been configured and customized, there is no need for the electronic device configuration tool 114 to remain near or in communication with the electronic device 111. Accordingly, the user 113 can take the electronic device configuration tool 114 and put it in his pocket, connect it to another electronic device to configure the same, or just look at it and marvel at how simple it was to customize the electronic device 111 using the method 100 of FIG. 1.

At step 110, the electronic device 111 has now been automatically transformed into a device that is configured and/or customized with the one or more user preferred electronic device settings 120. The electronic device 111 is now enabled with one or more functions, e.g., installed applications, new privacy settings, new communication connectivity channels, new user data presentation settings, new ringtones, new power operating mode settings, and so forth, that it did not have at step 101. In one or more embodiments, this configuration occurring at step 108 occurs automatically, and without any additional input from the user 113 beyond the delivery of the authentication data 118 at step 105. In this manner, the configuration and customization of the electronic device 111 by the electronic device configuration tool 114 occurs seamlessly and instantly. To the user 113, “it just works.”

The method 100 of FIG. 1 can be used in a variety of settings. Illustrating by example, if the electronic device 111 is a new device recently purchased from the manufacturer, using the method 100 of FIG. 1 the user 113 need only establish electronic communication 121 between the electronic device configuration tool 114 and the electronic device 111 at step 102 and deliver authentication data 118 at step 105 to quickly and conveniently configure and customize the electronic device 111 without the need of manually applying each and every customization by downloading applications, adjusting settings, and so forth. In another embodiment, the user 113 can quickly and conveniently customize a multi-user device as if it was their own using the electronic device configuration tool 114 and the method 100 of FIG. 1. Other beneficial and amazing uses for the method 100 of FIG. 1 will be obvious to those of ordinary skill in the art having the benefit of this disclosure.

In the illustrative embodiment of FIG. 1, the electronic device configuration tool 114 includes an authentication device 116 that is carried by the housing 115 of the electronic device configuration tool 114. Embodiments of the disclosure contemplate, however, that many electronic devices include authentication devices as well. For example, many smartphones include facial recognition modules and depth scanning modules. Accordingly, in one or more embodiments electronic device configuration tools configured in accordance with embodiments of the disclosure will receive authentication data from the authentication device of the electronic device to which the electronic device configuration tool is coupled, rather from a separate authentication device carried by the electronic device configuration tool. Turning now to FIG. 2, illustrated therein is one example of how this can occur.

Beginning at step 201, an electronic device 208, shown illustratively as a tablet computer, is initially in an unconfigured and/or uncustomized state. While shown illustratively as a tablet computer, it should be noted that the electronic device 208 could be any number of electronic devices, as noted above. The electronic device 208 may be in the unconfigured and/or uncustomized state, for example, if it is a new device having been shipped from the factory with only generic functions and applications loaded and operable on the electronic device 208.

As before, the electronic device 208 includes a communication interface with which it can communicate with an electronic device configuration tool. In the illustrative embodiment of FIG. 2, the communication interface comprises a physical interface with a physical connector to which an electronic device configuration tool can be coupled. The physical connector can take a variety of forms. For example, the physical connector can be any of a universal serial bus connector, secure digital card interface, high-definition multimedia connector, serial peripheral interface (SPI) connector, inter-integrated circuit (I2C) connector, universal asynchronous receiver-transmitter (UART) connector, or other connector. Other forms of communication interfaces will be obvious to those of ordinary skill in the art having the benefit of this disclosure. In this illustrative example, the physical connector comprises a universal serial bus connector.

At step 202 a user 209 attaches an electronic device configuration tool 210 to the communication interface of the electronic device 208. In this illustrative embodiment, the electronic device configuration tool 210 is configured as a small, handheld device that the user 209 can conveniently carry in a pocket, on a lanyard around their neck, or attached to a bracelet. In one or more embodiments, the electronic device configuration tool 210 includes a housing 211. In this illustrative embodiment, since the communication interface of the electronic device 208 comprises a physical interface with a connector, the electronic device configuration tool 210 includes a complementary connector 212, which is a universal serial bus connector in this example, and which serves as a communication interface for the electronic device configuration tool 210. As shown at step 202, the user 209 attaches the electronic device configuration tool 210 to the electronic device 208 by coupling the complementary connector 212 to the connector of the electronic device 208. The resulting connection, which establishes electronic communication between the electronic device 208 and the electronic device configuration tool 210 is shown at step 203.

In one or more embodiments, the electronic device 208 includes an authentication device 213 that is carried by the housing 214 of the electronic device 208. In one or more embodiments, the authentication device 213 is operable with one or more processors of the electronic device 208.

In this illustrative embodiment, the authentication device 213 comprises a fingerprint sensor. However, the authentication device 213 can take other forms as well. For example, in another embodiment the authentication device 213 can comprise an imager that performs facial recognition on the user 209. In another embodiment, the authentication device 213 comprises an audio input device that performs voice recognition on audio input received from the user 209. In still another embodiment, the authentication device 213 comprises a depth scanner that obtains a depth scan of a face of the user 209. In still other embodiments, the authentication device 213 can comprise a touchpad allowing the user 209 to enter a signature or personal identification number (PIN) carried on the authenticating device or the other device

Regardless of type, in one or more embodiments the authentication device 213 is configured to process authentication data received by the authentication device 213 to determine whether the authentication data is received from, or belongs to, an authorized user of the electronic device 208. The various authentication devices listed above are illustrative only, and can be used alone or in combination. Other examples of authentication devices will be obvious to those of ordinary skill in the art having the benefit of this disclosure.

In one or more embodiments, the electronic device configuration tool 210 takes advantage of this hardware supplied by the electronic device 208 to authenticate the user 209 as an authorized user of the electronic device configuration tool 210 as well. As shown at step 203, the user 209 is delivering authentication data 215 to the authentication device 213 of the electronic device 208. Since the authentication device 213 is a fingerprint sensor in this illustrative embodiment, the authentication data 215 comprises fingerprint data.

Since the authentication device 213 is a component of the electronic device 208, in this example step 203 comprises the one or more processors of the electronic device configuration tool 210 receiving 217 authentication data 216 from the electronic device 208 via the communication interface, rather than receiving the same at an authentication device carried by the electronic device configuration tool 210. Advantageously, the one or more processors of the electronic device configuration tool 210 can use authentication data received by the electronic device 208 to determine whether the user 209 is an authorized user of the electronic device configuration tool 210.

At decision 204, one or more processors of the electronic device configuration tool 210 determine whether the authentication data 216 received from the electronic device 208 at step 203 is received from an authorized user of the electronic device configuration tool 210. The one or more processors of the electronic device configuration tool 210 can compare the authentication data 216 received from the electronic device 208 with one or more predefined authentication references stored in the encrypted memory of the electronic device configuration tool 210 to determine whether the authentication data 216 sufficiently matches one or more of the predefined authentication references to confirm that the authentication data 216 belongs to, or is received from, an authorized user of the electronic device configuration tool 210.

Where the one or more processors of the electronic device configuration tool 210 fail to identify the authentication data 216 received from the electronic device 208 as belonging to, or being received from, an authorized user of the electronic device configuration tool 210, in one or more embodiments step 205 comprises the one or more processors of the electronic device configuration tool 210 leaving the electronic device 208 in the unconfigured or uncustomized state. This results in only the generic functions of the electronic device 208 to be operable on the electronic device 208, as noted above. In this condition, a person could still interact with the electronic device 208, but would be not be able to avail themselves to use, access, or see any user preferred settings, data, files, preferences, applications, application suites, and so forth of the authorized user that may be stored in the encrypted memory of the electronic device configuration tool 210.

By contrast, when the one or more processors of the electronic device configuration tool 210 confirm, at decision 204, that the authentication data 216 received from the electronic device 208 belongs to, or is received from, an authorized user of the electronic device configuration tool 210, the method moves to step 206. At step 206, the method comprises detecting, with one or more processors of the electronic device configuration tool 210, electronic communication 218 between the electronic device configuration tool 210 and the electronic device 208, determining 219, by the one or more processors of the electronic device configuration tool 210 from the electronic communication 218, a device type 221 of the electronic device 208, and selecting 220, by the one or more processors of the electronic device configuration tool 210 from an encrypted memory of the electronic device configuration tool 210, one or more user preferred electronic device settings corresponding to the device type 221 from a plurality of user preferred electronic device settings corresponding to a plurality of electronic device types. In this example, the one or more processors of the electronic device configuration tool 210 would select user preferred electronic device settings applicable for a tablet computer at step 206 due to the fact that the electronic device 208 was determined to be a smartphone at step 206.

At step 207, the one or more processors of the electronic device configuration tool 210 automatically configure 222 the electronic device 208 with the one or more user preferred electronic device settings 223. In one or more embodiments, the one or more processors of the electronic device configuration tool 210 automatically deliver, from the encrypted memory, one or more user preferred electronic device settings 223 to the physical communication interface, and thus to the electronic device 208. In one or more embodiments, the one or more processors of the electronic device configuration tool 210 automatically configure 222 the electronic device 208 with the one or more user preferred electronic device settings 223 only when the authentication data 216 received from the electronic device 208 sufficiently matches at least one authentication reference of the one or more authentication references stored in the encrypted memory of the electronic device configuration tool 210 so as to confirm the authentication data 216 was received from an authorized user of the electronic device configuration tool 210.

Once step 207 is complete, the user 209 can remove the electronic device configuration tool 210 from the communication interface of the electronic device 208. In one or more embodiments, this interrupts any electronic communication occurring between the electronic device 208 and the electronic device configuration tool 210. Embodiments of the disclosure contemplate that once the electronic device 208 has been configured and customized, there is no need for the electronic device configuration tool 210 to remain near or in communication with the electronic device 208. Accordingly, the user 209 can take the electronic device configuration tool 210 and put it in his pocket or connect it to another electronic device to configure the same using the method of FIG. 2.

Turning now to FIG. 3, additional details of electronic devices 300 operable with electronic device configuration tools configured in accordance with embodiments of the disclosure will be explored. As shown in FIG. 3, and as noted above, electronic devices 300 suitable for use with embodiments of the disclosure can take a variety of forms. Illustrative examples shown in FIG. 3 include an electronic device 111 configured as a smartphone, an electronic device 208 configured as a tablet computer, an electronic device 301 configured as a smart television, an electronic device 302 configured as a laptop computer, an electronic device 303 configured as a voice assistant, an electronic device 304 configured as a desktop computer, an electronic device 305 configured as a server, and an electronic device 303 configured as a router. These examples of electronic devices 300 are illustrative only, as numerous others will be obvious to those of ordinary skill in the art having the benefit of this disclosure.

In one or more embodiments, the electronic devices 300 optionally include a display 307, which may optionally be touch-sensitive. The display 307 can serve as a primary user interface of the electronic devices 300. Where, touch sensitive, users can deliver user input to the display 307 of such an embodiment by delivering touch input from a finger, stylus, or other objects disposed proximately with the display. In one embodiment, the display 307 is configured as an active matrix organic light emitting diode (AMOLED) display. However, it should be noted that other types of displays, including liquid crystal displays, would be obvious to those of ordinary skill in the art having the benefit of this disclosure.

The explanatory electronic devices 300 of FIG. 3 can optionally also include a housing. For example, the electronic device 208 configured as the tablet computer includes housing 214. Features can be incorporated into the housing 214. Examples of such features include the electronic device configuration tool receiver 308, which can mechanically receive, and electrically couple to, an electronic device configuration tool 210. The electronic device configuration tool receiver 308 can optionally include a connector 309 with which the electronic devices 300 can communicate by sending and receiving electrical signals to a corresponding connector 212 of the electronic device configuration tool 210 in one or more embodiments. In other embodiments, the communication between the electronic devices 300 and the electronic device configuration tool 210 will occur via wireless communication, such as via an optional near field communication circuit 350 or via a wireless communication channel established between the electronic device configuration tool 210 and a communication circuit 310.

Other examples of features that can be included along the housing include an imager, shown as camera, or an optional speaker port. A user interface component, which may be a button or touch sensitive surface, can also be disposed along the housing. The user interface component may be used to actuate an optional ejection mechanism 311 configured to decouple and detach the electronic device configuration tool 210 from the electronic devices 300.

A block diagram schematic 309 of the electronic devices 300 is also shown in FIG. 3. In one embodiment, the electronic devices 300 include one or more processors 313. In one embodiment, the one or more processors 313 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device. The application processor and the auxiliary processor(s) can be operable with the various components of the electronic devices 300. Each of the application processor and the auxiliary processor(s) can be configured to process and execute executable software code to perform the various functions of the electronic devices 300. A storage device, such as memory 314, can optionally store the executable software code used by the one or more processors 313 during operation.

In this illustrative embodiment, the electronic devices 300 also include a communication circuit 310 that can be configured for wired or wireless communication with one or more other devices or networks. The networks can include a wide area network, a local area network, and/or personal area network. The communication circuit 310 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication circuit 310 can include wireless communication circuitry, one of a receiver, a transmitter, or transceiver, and one or more antennas.

The electronic devices 300 can optionally include a near field communication circuit 350 used to exchange data, power, and electrical signals between the electronic devices 300 and the electronic device configuration tool 210. In one embodiment, the near field communication circuit 350 is operable with a wireless near field communication transceiver, which in one embodiment is a form of radio-frequency device configured to send and receive radio-frequency data to and from the electronic device configuration tool 210 or other near field communication objects. The near field communication circuit 350 can have its own near field communication circuit controller in one or more embodiments to wirelessly communicate with the electronic device configuration tool 210 using various near field communication technologies and protocols. The near field communication circuit 350 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with the electronic device configuration tool 210.

In one embodiment, the one or more processors 313 can be responsible for performing the primary functions of the electronic devices 300. For example, in one embodiment the one or more processors 313 comprise one or more circuits operable to present presentation information, such as images, text, and video, on the display 307. The executable software code used by the one or more processors 313 can be configured as one or more modules 315 that are operable with the one or more processors 313. Such modules 315 can store instructions, control algorithms, and so forth.

In one embodiment, the one or more processors 313 are responsible for running the operating system environment 316. The operating system environment 316 can include a kernel, one or more drivers, and an application service layer 317, and an application layer 318. The operating system environment 316 can be configured as executable code operating on one or more processors or control circuits of the electronic devices 300.

The application layer 318 can be responsible for executing application service modules. The application service modules may support one or more applications 319 or “apps.” Examples of such applications 319 include a cellular telephone application for making voice telephone calls, a web browsing application configured to allow the user to view webpages on the display 307 of the electronic devices 300, an electronic mail application configured to send and receive electronic mail, a photo application configured to organize, manage, and present photographs on the display 307 of the electronic devices 300, and a camera application for capturing images. Collectively, these applications constitute an “application suite.”

In one or more embodiments, these applications are operable either in a generic mode or a customized mode. For example, populating the photo application with the photographs of an authorized user enables a new function in the electronic devices 300 by allowing the one or more processors 313 of the electronic devices 300 to present information that was not presentable when the photo application was operating in a generic mode. In the generic mode, the photo application may only be able to present photographs captured by the camera application captured when the camera application is operating in the generic mode, for example.

Accordingly, when the electronic device configuration tool 210 delivers signals 320 including a user preferred electronic device settings 120, and those user preferred electronic device settings 120 either include the photographs belonging to an authorized user of the electronic device configuration tool 210, or alternatively provide one or more authorization credentials causing a login event connecting the communication circuit 310 of the electronic devices 300 to one or more cloud-based services 321 across a network 322 from which the photographs can be retrieved, these signals 320 enable a function of the electronic devices 300, which in this example is the ability to present photographs belonging to the authorized user of the electronic device configuration tool 210.

Similarly, the signals 320 can enable another function by altering the application suite operating on the electronic devices 300. If, for example, only five applications are operating on the electronic devices 300 when the electronic devices 300 is operating in the generic mode, they may be arranged on the display 307 in a predefined fashion. For example there may be four applications arranged in a line on the display 307, left to right, with the web browsing application followed by the electronic mail application. The photo application may then then follow by the camera application.

In one or more embodiments, when the electronic device configuration tool 210 delivers signals 320 including the user preferred electronic device settings 120, and those user preferred electronic device settings 120 include additional applications not stored on the electronic devices 300 when operating in the generic mode, these signals 320 enable a function of the electronic devices 300, which in this example is the ability to operate a new application on the electronic devices 300 that is not downloaded and operable with the electronic devices 300 is operating in the generic mode. Other examples of how the user preferred electronic device settings 120 can enable functions of the electronic devices 300 will be described below with reference to FIG. 4. Still others will be obvious to those of ordinary skill in the art having the benefit of this disclosure.

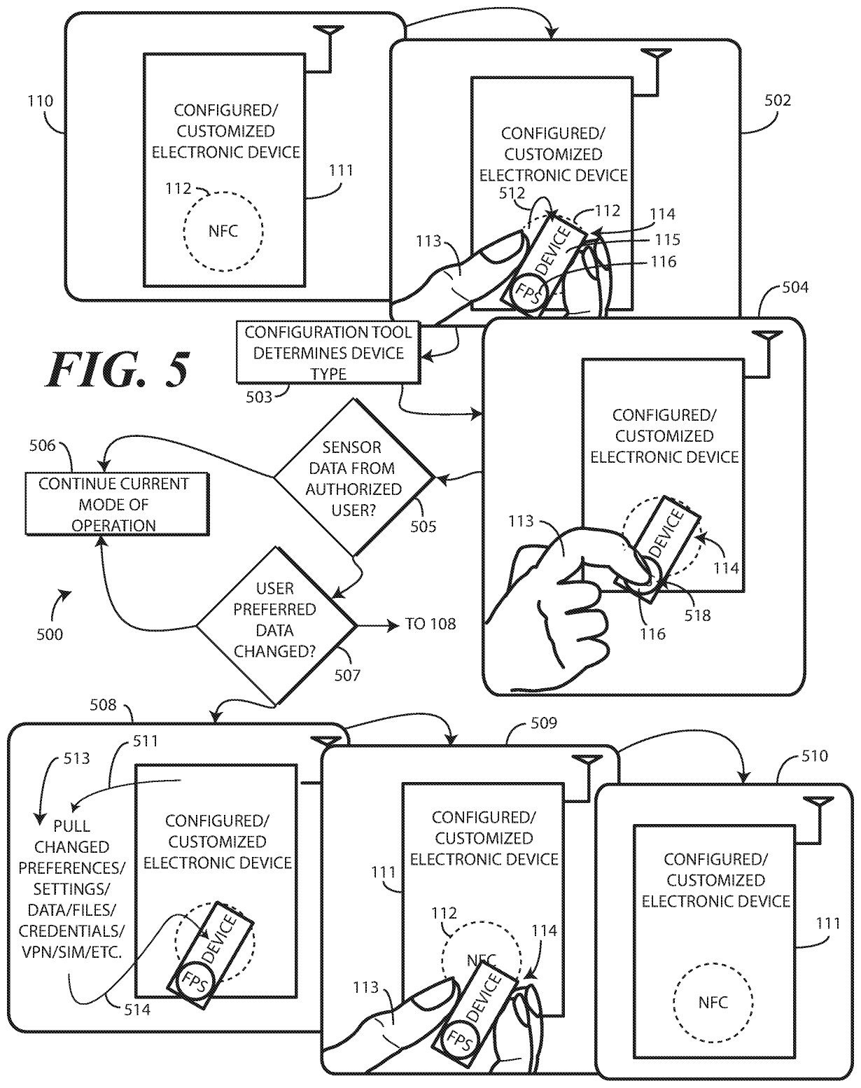

In one or more embodiments, the one or more processors 313 are responsible for managing the applications and all secure information received from the electronic device configuration tool 210 when operating on the electronic devices 300. The one or more processors 313 can also be responsible for launching, monitoring and killing the various applications and the various application service modules. In one or more embodiments, as will be shown and described below with reference to FIG. 5, the one or more processors 313 are further operable to write changes to the user preferred electronic device settings 120 to the electronic device configuration tool 210 when in communication with the same after changes to the user preferred electronic device settings 120 have been bade using the user interface 323 of the electronic devices 300.

The electronic devices 300 can include an optional locking mechanism 324 that is operable to retain the electronic device configuration tool 210 in a connected and coupled configuration attached to the electronic devices 300. The optional locking mechanism 324 can be a simple mechanical latch, such as a push-push locking mechanism in one embodiment. In other embodiments, the frictional connection between the connector 212 of the electronic device configuration tool 210 and the connector 309 of the electronic devices 300 will sufficiently retain the electronic device configuration tool 210 in a connected and coupled configuration where the electronic device configuration tool 210 is attached to the electronic devices 300.

In still other embodiments, the one or more processors 313 may generate commands to electronically control the optional locking mechanism 324 to either release the electronic device configuration tool 210 from the electronic device configuration tool receiver 308, or alternatively to physically retain the electronic device configuration tool 210 within the electronic device configuration tool receiver 308, as a function of user input received at the display 307, the user interface 323, or at another input device.

The one or more processors 313 can also be operable with other components 325. The other components 325, in one embodiment, include an acoustic detector, such as a microphone. The one or more processors 313 may process information from the other components 325 alone or in combination with other data, such as the information stored in the memory 314 or information received from the user interface.

The other components 325 can include a video input component such as an optical sensor, another audio input component such as a second microphone, and a mechanical input component such as button or key selection sensors, touch pad sensor, capacitive sensor, motion sensor, and switch. Similarly, the other components 325 can include video, audio, and/or mechanical outputs.

The other components 325 may include, but are not limited to, accelerometers, touch sensors, surface/housing capacitive sensors, audio sensors, and video sensors. Touch sensors may used to indicate whether the electronic devices 300 are being touched at side edges. The other components 325 of the electronic device can also include a device interface to provide a direct connection to auxiliary components or accessories for additional or enhanced functionality and a power source, such as a portable battery, for providing power to the other internal components and allow portability of the electronic devices 300.

It is to be understood that FIG. 3 is provided for illustrative purposes only and for illustrating components of some electronic devices 300 configured in accordance with embodiments of the disclosure, and is not intended to be a complete schematic diagram of the various components required for an electronic device. Therefore, other electronic devices in accordance with embodiments of the disclosure may include various other components not shown in FIG. 3, or may include a combination of two or more components or a division of a particular component into two or more separate components, and still be within the scope of the present disclosure.

Turning now to FIG. 4, illustrated therein is a block diagram schematic 401 of one explanatory electronic device configuration tool 210. It should be noted that the block diagram schematic 401 of FIG. 4 is provided for illustrative purposes only and for illustrating components of one electronic device configuration tool 210 in accordance with embodiments of the disclosure. The block diagram schematic of FIG. 4 is not intended to be a complete schematic diagram of the various components required for an electronic device configuration tool 210.

Therefore, other electronic device configuration tools configured in accordance with embodiments of the disclosure may include various other components not shown in FIG. 4, or may include a combination of two or more components or a division of a particular component into two or more separate components, and still be within the scope of the present disclosure. An electronic device configuration tool may have fewer, or different, components from another electronic device configuration tool configured in accordance with embodiments of the disclosure. Accordingly, electronic device configuration tools configured in accordance with embodiments of the disclosure can include some components that are not shown in FIG. 4, and other components that are shown may not be needed and can therefore be omitted.

The electronic device configuration tool 210 comprises a housing 211. Features can be incorporated into the housing 211. In this illustrative embodiment, an optional sensor 444 operable with an authentication device 432 is disposed along a surface of the housing 211. The sensor 444, where included, functions as an authentication data receiver for the authentication device 432.

In one embodiment, the sensor 444 is responsible for receiving authentication data and delivering the same to the authentication device 432. An example of this was described above with reference to FIG. 1. In other embodiments, however, the sensor 444 will be omitted and authentication data will be received from the electronic device to which the electronic device configuration tool 210 is coupled through the communication interface 415. An example of this was described above with reference to FIG. 2. In either configuration, the authentication device 432 is responsible for processing the authentication data received from either the sensor 444 or the other electronic device to authenticate or otherwise identify a user as an authorized user of the electronic device configuration tool 210.

Other features or devices can be disposed along the housing 211 as well. Examples of such devices include ribs or finger grips 450 for gripping the electronic device configuration tool 210 or an optional touch sensor 451 for detecting a person touching the housing 211 of the electronic device configuration tool 210.

In one embodiment, the sensor 444 operable with the authentication device 432 comprises a biometric sensor. In one or more embodiments, the biometric sensor comprises a fingerprint sensor 443, as previously described. However, other types of biometric sensors that can be substituted for the fingerprint sensor 443 will be obvious to those of ordinary skill in the art having the benefit of this disclosure. For example, in other embodiments the biometric sensor can be a voice interface engine 404 of an audio input/processor.

The voice interface engine 404 can include hardware, executable code, and speech monitor executable code in one embodiment. The voice interface engine 404 can include, stored in the encrypted memory 405, basic speech models, trained speech models, or other modules that are used by the voice interface engine 404 to receive and identify a particular user's voice commands that are received with audio input captured by an audio input device, such as one or more microphones situated along the housing 211 of the electronic device configuration tool 210. In one embodiment, the voice interface engine 404 performs voice recognition operations.

In another embodiment, the authentication device 432 can be an imager processor system. The imager processor system can be operable with sensors 444 of the electronic device configuration tool 210, such as a camera or imager 406, to identify the user through facial recognition techniques by capturing photographs of the user.

Where the authentication device 432 is configured as an imager processor system, the authentication device 432 can include one or more processors that are operable with one or more sensors 444. For example, in one or more embodiments the one or more sensors 444 operable with the imager processor system \comprise one or more of the aforementioned imager 406, a depth imager 407, and, optionally, one or more proximity sensors 409.

In one embodiment, the imager 406 comprises a two-dimensional imager configured to receive at least one image of an environment about the electronic device configuration tool 210. In one embodiment, the imager 406 comprises a two-dimensional Red-Green-Blue (RGB) imager. In another embodiment, the imager 406 comprises an infrared imager. Other types of imagers suitable for use as the imager 406 of electronic device configuration tool 210 will be obvious to those of ordinary skill in the art having the benefit of this disclosure.

The one or more proximity sensors 409, where included, can take various forms. In one or more embodiments, the one or more proximity sensors 409 fall in to one of two camps: active proximity sensors and “passive” proximity sensors. Either the proximity detector components or the proximity sensor components can be generally used for detecting persons and/or present within the environment, distances between warm objects and the electronic device configuration tool 210, changes in distance between warm objects and the electronic device configuration tool, and other information.

As used herein, a “proximity sensor component” comprises a signal receiver only that does not include a corresponding transmitter to emit signals for reflection off an object to the signal receiver. A signal receiver only can be used due to the fact that a user's body or other heat generating object external to the electronic device configuration tool 210 serves as the transmitter. In one embodiment, the signal receiver is an infrared signal receiver to receive an infrared emission from a source, such as a human being, when the human being is approaching the electronic device configuration tool 210.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

In one embodiment, the one or more proximity sensors 409 simply comprise a proximity sensor component. In another embodiment, the one or more proximity sensors 409 comprise a simple thermopile. In another embodiment, the one or more proximity sensors 409 comprise an infrared imager that captures the amount of thermal energy emitted by an object. In still other embodiments, the one or more proximity sensors 409 comprise a proximity detector component. Of course, combinations of these components can be used as the one or more proximity sensors 409. Moreover, other types of proximity sensors suitable for use with the electronic device configuration tool 210 will be obvious to those of ordinary skill in the art having the benefit of this disclosure.

As with the one or more proximity sensors 409, the depth imager 407, where included, can take a variety of forms. In a first embodiment, the depth imager 407 comprises a pair of imagers separated by a predetermined distance, such as three to four images. This “stereo” imager works in the same way the human eyes do in that it captures images from two different angles and reconciles the two to determine distance.

In another embodiment, the depth imager 407 employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 407 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained.

In one or more embodiments where the authentication device 432 is configured as an imager processor system, it can function as one or both of a face analyzer and/or an environmental analyzer. Where so configured, the authentication device 432 can be configured to process an image or depth scan of an object and determine whether the object matches predetermined criteria by comparing the image or depth scan to one or more predefined authentication references 410 stored in the encrypted memory 405.

In one or more embodiments, the authentication device 432 can determine whether a person is an authorized user of the electronic device configuration tool 210. In one or more embodiments, the authentication device 432 can employ optical and/or spatial recognition to identify persons or objects using image recognition, character recognition, visible recognition, facial recognition, color recognition, shape recognition, and the like. Advantageously, in one or more embodiments the authentication device 432 can be used as a facial recognition device and/or electronic device configuration tool recognition device in one or more embodiments.

In one or more embodiments, one or both of the imager 406 and/or the depth imager 407 can capture a photograph and/or depth scan of a person. The authentication device 432 can then compare the image and/or depth scan to one or more predefined authentication references 410 stored in the encrypted memory 405. With respect to a person, this comparison, in one or more embodiments, is used to confirm beyond a threshold authenticity probability that the person's face—both in the image and the depth scan—sufficiently matches one or more of the predefined authentication references 410 stored in the encrypted memory 405 for the authentication device 432 to identify the person as being an authorized user of the electronic device configuration tool 210.

In another embodiment, the sensor 444 operable with the authentication device 432 can be something other than a biometric sensor. For example, in another embodiment the sensor 444 operable with the authentication device 432 can be a user interface device 408, such as a keypad or touch screen, with which a user can enter authentication data. For example, in one embodiment the sensor 444 operable with the authentication device 432 comprises a user interface device allowing a person to enter a password or personal identification number (PIN) to authenticate themselves as the authorized user of the electronic device configuration tool 210. Other examples of sensors 444 suitable for use with the authentication device 432 in the electronic device configuration tool 210 will be obvious to those of ordinary skill in the art having the benefit of this disclosure.

Where the authentication device 432 is operable with a fingerprint sensor 443, be it one carried by the electronic device configuration tool 210 or carried by the electronic device to which the electronic device configuration tool 210 is coupled, in one or more embodiments it includes its own processor to perform various functions, including detecting a finger touching the fingerprint sensor 443, capturing and storing fingerprint data from the finger, and optionally identifying or authenticating a user based upon the fingerprint data. In one or more embodiments the processor of the fingerprint sensor 443 can, as one pre-processing step, perform a preliminary authentication of the user by comparing fingerprint data captured by the fingerprint sensor 443 to a reference file stored in the encrypted memory 405, while secondary authentication is performed by the one or more processors 402. The processor of the fingerprint sensor 443 can be an on-board processor. Alternatively, the processor can be a secondary processor that is external to, but operable with, the fingerprint sensor in another embodiment. Other configurations will be obvious to those of ordinary skill in the art having the benefit of this disclosure.

In one embodiment, the fingerprint sensor 443 can include a plurality of sensors. The fingerprint sensor 443 can be a complementary metal-oxide-semiconductor active pixel sensor digital imager or any other fingerprint sensor. The fingerprint sensor 443 can be configured to capture, with the plurality of sensors, a live scan of a fingerprint pattern from a finger disposed along its surface, and to store this information as fingerprint data from the user's finger. The fingerprint sensor 443 may also be able to capture one or more images with the plurality of sensors. The images can correspond to an area beneath a surface of skin. The fingerprint sensor 443 can compare the fingerprint data or skin images to one or more references to authenticate a user in an authentication process. While the fingerprint sensor 443 is disposed along a top surface of the housing 211 in this illustration, it should be noted that it could alternatively be disposed along the bottom surface of the housing 211 or on the sides of the housing in other embodiments.

The electronic device configuration tool 210 includes one or more processors 402. The one or more processors 402 can be operable with the various components of the electronic device configuration tool 210. The one or more processors 402 can be configured to process and execute executable software code to perform the various functions of the electronic device configuration tool 210. A storage device, such as the encrypted memory 405, can optionally store the executable software code used by the one or more processors 402 during operation.

In one or more embodiments, the encrypted memory 405 can store one or more user preferred electronic device settings 120. In one or more embodiments, the one or more user preferred electronic device settings 120 comprise one or more of one or more user preferred settings 411, one or more user preferences 412, one or more user preferred configurations 413, and/or user data 414 belonging to an authorized user of the electronic device configuration tool 210.

In one or more embodiments, the one or more processors 402 are configured to automatically deliver, from the encrypted memory 405 upon the authentication device 432 confirming that received authentication data was received from an authorized user of the electronic device configuration tool 210, the one or more user preferred settings 411, one or more user preferences 412, one or more user preferred configurations 413, and/or user data 414 to the communication interface 415 of the electronic device configuration tool 210 for delivery to another electronic device to configure the other electronic device with the one or more user preferred electronic device settings 120. In one or more embodiments, the one or more processors 402 are configured to automatically deliver, from the encrypted memory 405, the one or more user preferred settings 411, one or more user preferences 412, one or more user preferred configurations 413, and/or user data 414 to the communication interface 415 of the electronic device configuration tool 210 for delivery to another electronic device to configure the other electronic device with the one or more user preferred electronic device settings 120 only where authentication data received by the authentication device 432 sufficiently matches at least one authentication reference of the one or more authentication references 410 stored in the encrypted memory 405 so as to confirm that the authentication data was received from an authorized user of the electronic device configuration tool 210.

In one or more embodiments, prior to delivering the user preferred electronic device settings 120 to the communication interface 415, the one or more processors 402 first identify whether the other electronic device is already configured with any user preferred electronic device settings of the user preferred electronic device settings 120. In one or more embodiments, where the one or more processors 402 fail to identify the other electronic device being configured with the any user preferred electronic device settings of the plurality of user preferred electronic device settings 120, the one or more processors 402 push the one or more user preferred electronic device settings 120 to the other electronic device through the communication interface 415. However, where the one or more processors 402 identify the other electronic device being configured with the any user preferred electronic device settings of the plurality of user preferred electronic device settings 120, the one or more processors 402 pull one or more changed user preferred electronic device settings from the other electronic device upon identifying the changes to the one or more user preferred electronic device settings. Thereafter, the one or more processors 402 can store the one or more changed user preferred electronic device settings in the encrypted memory 405.

Since the user preferred electronic device settings 120 can correspond to a large number of electronic devices, including the electronic devices (111,208,301,302,303,304,305,306) of FIG. 3, in one or more embodiments the one or more processors 402 first identify an electronic device type of the other electronic device through the communication interface 415 from signals 423 received by the communication interface 415 from the other electronic device. The one or more processors 402 select only the user preferred electronic device settings 120 appropriate for that device type from the plurality of user preferred electronic device settings 120 stored in the encrypted memory 405. Thereafter, the one or more processors 402 send only the user preferred electronic device settings 120 appropriate for that device type to the communication interface 415 and then to the other electronic device. In one or more embodiments, one or more of the one or more user preferred settings 411, one or more user preferences 412, one or more user preferred configurations 413, and/or user data 414 enable one or more functions of the electronic device receiving the one or more user preferred settings 411, one or more user preferences 412, one or more user preferred configurations 413, and/or user data 414.

The communication interface 415 of the electronic device configuration tool 210 can take a variety of forms. Illustrating by example, in one or more embodiments the communication interface 415 is a physical interface 416. In one or more embodiments, the physical interface 416 comprises a universal serial bus connector 417. In other embodiments, the physical interface 416 comprises a secure digital card interface 418. Other examples of physical interfaces for the communication interface 415 will be obvious to those of ordinary skill in the art having the benefit of this disclosure. Illustrating by example, in other embodiments the communication interface 415 can comprise a serial peripheral interface (SPI) connector, inter-integrated circuit (I2C) connector, universal asynchronous receiver-transmitter (UART) connector, or other type of connector.

In other embodiments, the communication interface 415 comprises a wireless interface 419. In one or more embodiments, the wireless interface 419 comprises a near-field communication interface 420. In another embodiment, the wireless interface 419 comprises a wireless fidelity interface 421. In still other embodiments, the communication interface 415 comprises a Bluetooth interface 422. Other examples of wireless interfaces will be obvious to those of ordinary skill in the art having the benefit of this disclosure. For example, in another embodiment the wireless interface 419 comprises an ad hoc or peer-to-peer interface.

In one or more embodiments, the communication interface 415 delivers the user preferred electronic device settings 120, which can include one or more user preferred settings 411, one or more user preferences 412, one or more user preferred configurations 413, and/or user data 414, to an electronic device with which the electronic device configuration tool 210 is in electronic communication. In one or more embodiments, the communication interface 415 also optionally receives power from the electronic device to which the electronic device configuration tool 210 is coupled. In one or more embodiments, this power received from the other electronic device through the communication interface 415 is used to actuate and power the one or more processors 402 of the electronic device configuration tool 210, as well as the other components operable with the one or more processors 402. Power conversion/storage circuitry 441 can optionally be included to buffer and/or process the received power used by the one or more processors 402 of the electronic device configuration tool 210 where the electronic device configuration tool 210 is so configured.

In one or more embodiments, the one or more processors 402 automatically deliver, from the encrypted memory 405, and after confirming that authentication data received by the authentication device 432 is received from an authorized user of the electronic device configuration tool 210, the one or more user preferred settings 411, one or more user preferences 412, one or more user preferred configurations 413, and/or user data 414. In one or more embodiments, this occurs only while power received from the communication interface 415 is actuating and/or powering the one or more processors 402. In one or more embodiments, this occurs only when user authentication data received by the authentication device 432 sufficiently matches at least one authentication reference of the one or more authentication references 410 so as to confirm the user authentication data was received from an authorized user of the electronic device configuration tool 210.

Where the authentication device 432 is configured to be operable with the fingerprint sensor 443, the one or more processors 402 can deliver signals 423 to the communication interface 415 that enable one or more functions of the electronic device to which the electronic device configuration tool 210 is coupled upon confirming that fingerprint data received by the fingerprint sensor 443 belongs to an authorized user of the electronic device configuration tool 210. In one or more embodiments, the one or more processors 402 deliver the one or more user preferred settings 411, one or more user preferences 412, one or more user preferred configurations 413, and/or user data 414 to configure the electronic device to which the electronic device configuration tool 210 is coupled when the electronic device configuration tool 210 is coupled to that electronic device and the authentication device 432 identifies received fingerprint data as belonging to the authorized user of the electronic device configuration tool 210.

The one or more user preferred settings 411, one or more user preferences 412, one or more user preferred configurations 413, and/or user data 414 can take a variety of forms. For example, the one or more user preferred settings 411, one or more user preferences 412, one or more user preferred configurations 413, and/or user data 414 can include data, information, and preferences that the electronic device to which the electronic device configuration tool 210 is coupled can load, process, execute, present, or transmit. Additionally, the one or more user preferred settings 411, one or more user preferences 412, one or more user preferred configurations 413, and/or user data 414 can comprise files 452, preferences, and applications preferred by the user. For example, the one or more user preferred settings 411 can include one or more user files, which can be automatically delivered to another electronic device upon the one or more processors 402 of the electronic device configuration tool 210 confirming that fingerprint data received by the fingerprint sensor 443 belongs to an authorized user of the electronic device configuration tool 210.

Examples include function-enabling data 424. For example, if the electronic device to which the electronic device configuration tool 210 is coupled includes facial recognition capabilities, the function-enabling data 424 may include one or more predefined authentication references to which the facial recognition hardware can compare captured images or facial depth scans to identify the authorized user of the electronic device configuration tool 210 as the authorized user of the electronic device to which the electronic device configuration tool 210 is coupled. Accordingly, delivery of this function-enabling data 424 would enable the facial recognition function to be performed using the facial recognition hardware in one or more embodiments.

The one or more user preferred configurations 413 can comprise various settings. These settings can include such as ringtone preferences 425, font size preferences 426, screen brightness preferences 427, audio setting preferences, call handling preferences, data handling preferences, application suite preferences 428, or other information. For example, the one or more user preferred configurations 413 can be delivered to another electronic device in the form of signals that cause a predefined application suite to be loaded on the other electronic device. The one or more user preferred settings 411, one or more user preferences 412, one or more user preferred configurations 413, and/or user data 414 can also include preferred electronic devices 429 to connect to, preferred power modes 430 of operation, preferred authenticating technologies 431, preferred presence scanning duty cycles 433, preferred methods of connection 434, and so forth.

The one or more user preferred settings 411, one or more user preferences 412, one or more user preferred configurations 413, and/or user data 414 can include other information as well. For instance, in one or more embodiments the one or more user preferred settings 411, one or more user preferences 412, one or more user preferred configurations 413, and/or user data 414 comprises virtual private network communication preferences 435 and credentials 436 for communication with other electronic devices across a network.

In one or more embodiments, the one or more user preferred settings 411, one or more user preferences 412, one or more user preferred configurations 413, and/or user data 414 comprises subscriber identification module information 437 that allows the electronic device to which the electronic device configuration tool 210 is coupled to transmit and receive voice calls, transmit and receive text messages, and otherwise use data from a subscription plan purchased by the authorized user of the electronic device configuration tool. The one or more user preferred settings 411, one or more user preferences 412, one or more user preferred configurations 413, and/or user data 414 can also comprise credentials 438 used to access services in the “cloud.” For example, the credentials 438 stored in the encrypted memory 405 could allow the electronic device to which the electronic device configuration tool 210 is coupled to access to accounts, application, data, and services stored on a remote server across a network in one or more embodiments. These examples of what can be stored in the encrypted memory 405 are illustrative only. Numerous others will be obvious to those of ordinary skill in the art having the benefit of this disclosure. For example, the one or more user preferred settings 411, one or more user preferences 412, one or more user preferred configurations 413, and/or user data 414 can include contextual preferences 439 used to prioritize which actuation signals are delivered to the communication interface 415 as previously described, active web browser pages, web browser bookmarks 440, or other information.

In one or more embodiments, the electronic device configuration tool 210 comprises an optional ejection mechanism 442 configured to facilitate decoupling and detachment of the electronic device configuration tool 210 from another the electronic device. Illustrating by example, in one or more embodiments the touch sensor 403 is configured to be operable with the ejection mechanism 442 such that the ejection mechanism 442 detects an ejection event when a person touches the housing 211 of the electronic device configuration tool. In other embodiments, the one or more processors 402 will detect an ejection event when communication at the communication interface 415 between the electronic device configuration tool 210 and another electronic device ceases.

In one or more embodiments, when the one or more processors 402 detect cessation of electronic communication between the electronic device configuration tool 210 and another electronic device and, thereafter, reestablishment of the electronic communication with the other electronic device, upon detecting the reestablishment of the electronic communication with the other electronic device the one or more processors 402 query the other electronic device for changes to the user preferred electronic device settings 120. Where the user has made changes, alterations, adjustments, additions, or deletions to or from the user preferred electronic device settings 120, in one or more embodiments the one or more processors 402 retrieve the changed user preferred electronic device settings from the other electronic device and store the changed user preferred electronic device settings in the encrypted memory 405. Turning now to FIG. 5, illustrated therein is one method 500 by which this can occur.

The method 500 of FIG. 5 begins at step 110 from FIG. 1. At step 110, the electronic device 111 has been automatically transformed into a device that is configured and/or customized with the one or more user preferred electronic device settings (120) using the method of FIG. 1. Accordingly, the electronic device 111 is now enabled with one or more functions, e.g., installed applications, new privacy settings, new communication connectivity channels, new user data presentation settings, new ringtones, new power operating mode settings, and so forth.

As before, the electronic device 111 includes a communication interface 112 with which it can communicate with an electronic device configuration tool. In the illustrative embodiment of FIG. 5, the communication interface 112 comprises a wireless communication interface without a physical connector. In this illustrative embodiment, the communication interface 112 is configured as a near-field communication interface. As described above with reference to FIG. 3, the communication interface 112 can alternatively include a physical interface with a physical connector to which an electronic device configuration tool can be coupled.

At step 110, there is no electronic device configuration tool in communication with the communication interface 112. This is due to the fact that the electronic device configuration tool (114) of FIG. 1 was removed from the communication interface 112 at step (109) of the method (100) of FIG. 1. Accordingly, the one or more processors of that electronic device configuration tool (114) would detect cessation of the electronic communication with the electronic device 111 at step (109) of the method (100) of FIG. 1.

At step 502 a user 113 places an electronic device configuration tool 114 on the housing of the electronic device 111 atop the communication interface 112 of the electronic device 111. By exchanging wireless communication signals with the communication interface 112 of the electronic device 111, one or more processors of the electronic device configuration tool 114 can reestablish electronic communication 512 with the electronic device 111.

In this example, the electronic device configuration tool 114 includes an authentication device 116 that is carried by the housing 115 of the electronic device configuration tool 114. In one or more embodiments, the authentication device 116 is operable with one or more processors of the electronic device configuration tool 114. In this illustrative embodiment, the authentication device 116 comprises a fingerprint sensor.

At optional step 503, the one or more processors of the electronic device configuration tool 114, in response to detecting the communication interface of the electronic device configuration tool reestablishing electronic communication 512 with the communication interface 112 of the electronic device 111, identify an electronic device type of the electronic device 111 from signals received from the electronic device 111 through the communication interface. In this example, the electronic device 111 is a smartphone. Accordingly, at optional step 503 the one or more processors of the electronic device configuration tool 114 determine this device type by querying the electronic device 111 and receiving signals 121 in response through the communication interface.

At step 504, the user 113 is delivering authentication data 518 to the authentication device 116 of the electronic device configuration tool 114. Since the authentication device 116 is a fingerprint sensor in this illustrative embodiment, the authentication data 518 comprises fingerprint data, with step 105 comprising the authentication device 116 receiving authentication data in the form of fingerprint data.

At decision 505, the one or more processors of the electronic device configuration tool 114 determine whether the authentication data 518 received from the user 113 at step 504 is received from an authorized user of the electronic device configuration tool 114. The one or more processors of the electronic device configuration tool 114 can compare the authentication data 518 with one or more predefined authentication references stored in the encrypted memory of the electronic device configuration tool 114 to determine whether the authentication data sufficiently matches one or more of the predefined authentication references to confirm that the authentication data 518 belongs to, or is received from, an authorized user of the electronic device configuration tool 114. Thus, in one or more embodiments decision 505 comprises the one or more processors of the electronic device configuration tool 114 determining, with the authentication device 116, whether subsequent authentication data 518 received by the authentication device 116 at step 504 (subsequent because it is subsequent to that received at step (105) of the method (100) of FIG. 1) belongs to the authorized user of the electronic device configuration tool 114.

Where the one or more processors of the electronic device configuration tool 114 fail to identify the authentication data 518 as belonging to, or being received from, an authorized user of the electronic device configuration tool 114, in one or more embodiments step 506 comprises the one or more processors of the electronic device configuration tool 114 leaving the electronic device 111 to continue operating in the configured and/or customized state, taking no action. This results in the customized and configured functions of the electronic device 111 remaining operable on the electronic device 111. Users of the electronic device 111 can interact with the electronic device 111 and avail themselves to use, access, or see any user preferred settings, data, files, preferences, applications, application suites, and so forth of the authorized user that were used to customize and configure the electronic device 111 using the method (100) of FIG. 1. By contrast, when the one or more processors of the electronic device configuration tool 114 confirm that, at decision 505, the authentication data 518 belongs to, or is received from, an authorized user of the electronic device configuration tool 114, the method 500 moves to decision 507.

At decision 507, after detecting reestablishment of the electronic communication 512, the one or more processors of the electronic device configuration tool 114 identify whether the electronic device 111 is configured with any user preferred electronic device settings of the plurality of user preferred electronic device settings (120) stored within the encrypted memory of the electronic device configuration tool 114. If there were no user preferred electronic device settings of the plurality of user preferred electronic device settings (120) stored within the encrypted memory of the electronic device configuration tool 114 in the electronic device 111, the method 500 would move to step 108 of FIG. 1. Said differently, where the one or more processors of the electronic device configuration tool 114 fail to identify the electronic device 111 being configured with the any user preferred electronic device settings of the plurality of user preferred electronic device settings (120) stored within the encrypted memory of the electronic device configuration tool 114, the method 500 could move to step 108 where the one or more processors of the electronic device configuration tool 114 push the one or more user preferred electronic device settings (120) to the electronic device 111 through the communication interface.

However, where the one or more processors identify, at decision 507, the electronic device 111 being configured with the any user preferred electronic device settings of the plurality of user preferred electronic device settings (120) stored within the encrypted memory of the electronic device configuration tool 114, in one or more embodiments decision 507 further comprises the one or more processors of the electronic device configuration tool 114 determining whether changes to the user preferred electronic device settings (120) have occurred in the electronic device 111. Said differently, at decision 507, and after detecting reestablishment of the electronic communication 512, in one or more embodiments the one or more processors of the electronic device configuration tool 114 query the electronic device 111 to determine whether changes have occurred to the user preferred electronic device settings (120) delivered at step (108) of the method (100) of FIG. 1 in the electronic device 111. Thus, in one or more embodiments decision 507 further comprises detecting, by the one or more processors of the electronic device configuration tool 114 from the reestablished electronic communication 512, whether one or more changes have been applied to the one or more user preferred electronic device settings (120) delivered at step (108) of the method (100) of FIG. 1 and corresponding to the device type determined at step 503 in the electronic device 111.

Where no changes have occurred, the method 500 moves again to step 506. However, where there have been changes to the user preferred electronic device settings, the method 500 moves to step 508 where the one or more processors of the electronic device configuration tool 114 pull 511 one or more changed user preferred electronic device settings 513 from the electronic device 111 and storing the one or more changed user preferred electronic device settings 513 in the encrypted memory of the electronic device configuration tool 114. Thus, in one or more embodiments step 506 comprises the one or more processors of the electronic device configuration tool 114 retrieving one or more changed user preferred electronic device settings 513 from the electronic device 111 upon identifying the changes to the one or more user preferred electronic device settings (120) at decision 507 and storing 514 the one or more changed user preferred electronic device settings 513 in the encrypted memory of the electronic device configuration tool 114. Effectively, where changes have been applied to the one or more user preferred electronic device settings (120) corresponding to the device type at the electronic device 111, step 506 comprises retrieving one or more changed user preferred electronic device settings 513 from the electronic device 111 and storing 514 the one or more changed user preferred electronic device settings 513 in the encrypted memory of the electronic device configuration tool 114. In one or more embodiments, the storing 514 of the one or more changed user preferred electronic device settings 513 from the electronic device 111 occurs only where the subsequent authentication data 518 received by the authentication device 116 belongs to the authorized user of the electronic device configuration tool 114.

The electronic device configuration tool 114 is now updated with the changed user preferred electronic device settings 513. At step 509, the user 113 can remove the electronic device configuration tool 114 from the communication interface 112 of the electronic device 111, thereby again interrupting any electronic communication occurring between the electronic device 111 and the electronic device configuration tool 114. Since the electronic device 111 has been configured and customized, there is no need for the electronic device configuration tool 114 to remain near or in communication with the electronic device 111. Accordingly, the user 113 can take the electronic device configuration tool 114 and put it in his pocket, connect it to another electronic device to configure the same, or lock it in a safe, with the electronic device 111 remaining customized and configured at step 510.

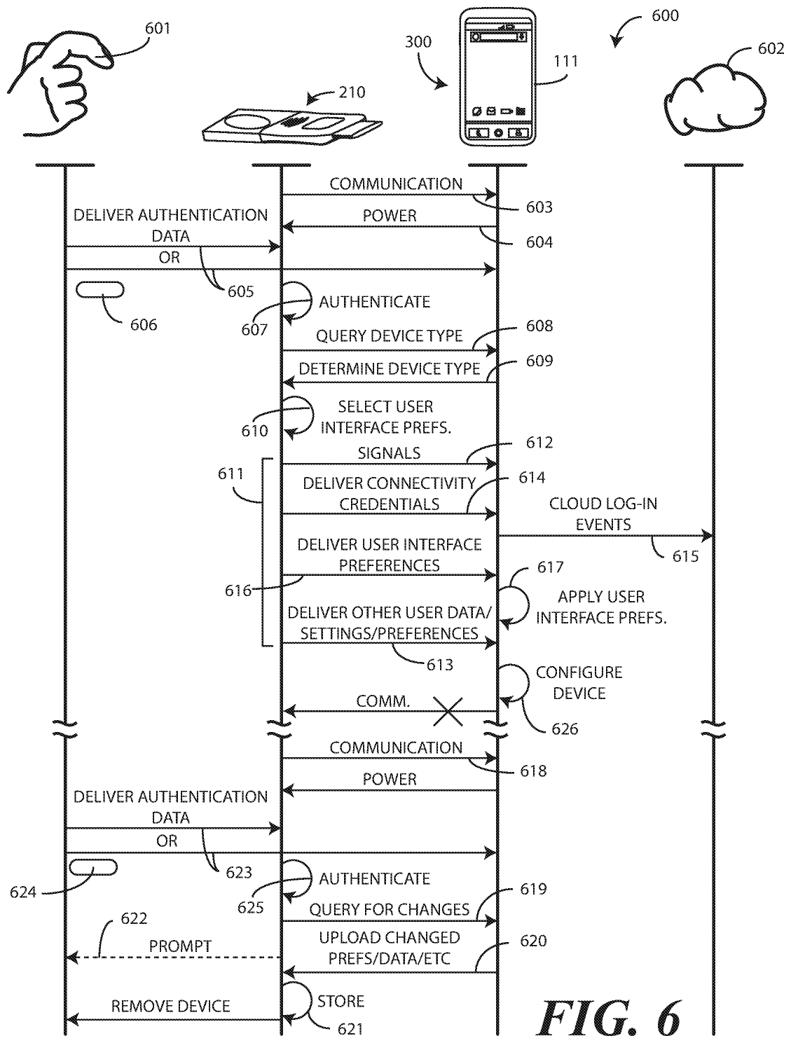

Turning now to FIG. 6, illustrated therein is one explanatory system, method, and signal flow diagram 600 in accordance with one or more embodiments of the disclosure. Represented in the system, method, and signal flow diagram 600 are an authorized user 601 of an electronic device configuration tool 210, the electronic device configuration tool 210, an electronic devices 300 with which the electronic device configuration tool 210 can establish electronic communications, one example of which is electronic device 111, and one or more cloud services and systems 602 with which the electronic device configuration tool 210 can establish electronic communications. The one or more cloud services and systems 602 generally represent one or more remote servers, computers, and devices that are networked together to operate as a single ecosystem. These one or more remote servers, computers, and devices can be configured to store data, manage data, run applications, deliver content, and perform other functions across the network.

Initially, electronic communications 603 are established between the electronic device configuration tool 210 and an electronic device 111. In one or more embodiments, this occurs when a physical communication interface of the electronic device configuration tool 210 is electrically coupled to a physical communication interface of the electronic device 111. In another embodiment, this occurs when a wireless communication interface of the electronic device configuration tool 210 established the electronic communications 603 with a wireless communication interface of the electronic device 111.

One or more processors of the electronic device configuration tool 210 detect establishment of this electronic communication 603. In one or more embodiments, one or more processors of the electronic device configuration tool 210 are then actuated by power 604 received from the electronic device 111 via the communication interface establishing electronic communication between the electronic device 111 and the electronic device configuration tool 210.

The authorized user 601 then delivers 605 authentication data 606 to a sensor of either the electronic device configuration tool 210 or the electronic device 111. In one or more embodiments, the authentication data 606 comprises fingerprint data delivered to a fingerprint sensor of the electronic device configuration tool 210. In another embodiment, the authentication data 606 comprises fingerprint data delivered to a fingerprint sensor of the electronic device 111, with the electronic device 111 then delivering the fingerprint data to the electronic device configuration tool 210.

An authentication device or one or more processors of the electronic device configuration tool 210 then compare 607 the authentication data 606 to one or more authentication references stored in an encrypted memory of the electronic device configuration tool 210 to determine whether the authentication data sufficiently matches at least one authentication reference of the one or more authentication references so as to confirm that the authentication data was received from an authorized user of the electronic device configuration tool 210.

In one or more embodiments, the one or more processors of the electronic device configuration tool 210 then query the electronic devices 300 to determine 608 what type of device the electronic device 111 is by delivering signals to the communication interface between the electronic devices 300 and the electronic device configuration tool 210, determining 609 the same from signals received from the communication interface between the electronic device 111 and the electronic device configuration tool 210.

In one or more embodiments, the one or more processors of the electronic device configuration tool 210 then select 610 one or more user preferred electronic device settings applicable to the electronic device type of the electronic device 111 from the plurality of user preferred electronic device settings as a function of the electronic device type. The one or more processors of the electronic device configuration tool 210 then, in one or more embodiments, automatically configure the electronic device 111 with the one or more user preferred electronic device settings 611 by delivering one or more electronic device configuration signals to the electronic device 111.

Illustrating by example, the one or more processors of the electronic device configuration tool 210 can deliver signals 612 to the communication interface established between the electronic device 111 and the electronic device configuration tool 210. In one or more embodiments, the one or more processors of the electronic device configuration tool 210 deliver the signals 612 to the communication interface established between the electronic device 111 and the electronic device configuration tool 210 upon confirming 707 the authentication data 606 received by the authentication device of the electronic device configuration tool 210 belongs to, or was received from, the authorized user 601 of the electronic device configuration tool 210.

In one or more embodiments, the signals 612 delivered to the communication interface established between the electronic device 111 and the electronic device configuration tool 210 comprise one or more of one or more user preferred settings, one or more user preferences, one or more user preferred configurations, and/or user data stored in an encrypted memory of the electronic device configuration tool 210. For example, in one or more embodiments the one or more processors of the electronic device configuration tool 210 automatically deliver 613 one or more user preferred settings to the communication interface established between the electronic device 111 and the electronic device configuration tool 210 upon the one or more processors of the electronic device configuration tool 210 determining 607 the authentication data 606 sufficiently matches at least one authentication reference of the one or more authentication references stored in the encrypted memory of the electronic device configuration tool 210 so as to confirm the user authentication data was received from an authorized user 601 of the electronic device configuration tool 210.

These one or more user preferred settings can include a ringtone preference, a font size preference, an audio setting preference, a call handling preference, a data preference, a screen brightness preference, or an application suite preference. Other examples of user preferred settings will be obvious to those of ordinary skill in the art having the benefit of this disclosure. In effect, the one or more processors of the electronic device configuration tool 210 configure 626 the electronic device 111 with the various user preferred settings when the electronic device configuration tool 210 is in communication with the electronic device 111 and the authentication data 606 received by the authentication device of the electronic device configuration tool 210 belongs to the authorized user 601 of the electronic device configuration tool 210.

In one or more embodiments, the one or more processors of the electronic device configuration tool 210 can also deliver 614 one or more authorization credentials allowing the electronic device 111 to access one or more services, such as one or more services from the one or more cloud services or systems 602. In one or more embodiments, the one or more processors of the electronic device configuration tool 210 automatically deliver 614 the one or more authorization credentials to the communication interface established between the electronic device 111 and the electronic device configuration tool 210 upon the one or more processors of the electronic device configuration tool 210 confirming the authentication data 606 received by the authentication device of the electronic device configuration tool 210 belongs to an authorized user of the electronic device configuration tool 210. In one or more embodiments, the one or more authorization credentials automatically cause 615 one or more login events connecting the electronic device 111 to one or more cloud based services, e.g., the one or more cloud services or systems 602, across a network. Similarly, the one or more authorization credentials can comprise one or more of virtual private network credentials, subscriber identification module credentials, or other types of credentials as well.

In one or more embodiments, the one or more processors of the electronic device configuration tool 210 also deliver 616 one or more user interface preferences to the electronic device 111. In one or more embodiments, these one or more user interface preferences can be automatically applied 617 to configure and customize the electronic device 111. Once the electronic device 111 is configured, the electronic communication 603 can cease, either by decoupling the physical communication interface of the electronic device configuration tool 210 from the physical communication interface of the electronic device 111, or alternatively moving the electronic device configuration tool 210 away from the electronic device 111 so as to cause a cessation of the electronic communication 603 between the wireless communication interface of the electronic device configuration tool 210 and the wireless communication interface of the electronic device 111.

As the authorized user 601 uses the electronic device 111, it is contemplated that there will be situations in which the authorized user 601 modifies the one or more user preferred settings, one or more user preferences, one or more user preferred settings, and/or user data at the electronic device 111. Embodiments of the disclosure allow the electronic device configuration tool 210 pull one or more changed user preferred electronic device settings from the electronic device 111 upon identifying the changes to the one or more user preferred electronic device settings. The one or more changed user preferred electronic device settings from the electronic device 111 can then be stored in the encrypted memory of the electronic device configuration tool 210.

Accordingly, in one or more embodiments the one or more processors of the electronic device configuration tool 210 detect cessation of the electronic communication 603 with the electronic device 111. Sometime thereafter, the one or more processors of the electronic device configuration tool 210 then detect reestablishment 618 of the electronic communication with the electronic device 111. In one or more embodiments, upon detecting the reestablishment 618 of the electronic communication with the electronic device 111, the one or more processors of the electronic device configuration tool 210 query 619 the electronic device 111 for changes to the one or more user preferred electronic device settings.

Where there are changes, in one or more embodiments the one or more processors of the electronic device configuration tool 210 retrieve 620 one or more changed user preferred electronic device settings from the electronic device 111 and store 621 the one or more changed user preferred electronic device settings in the encrypted memory of the electronic device configuration tool 210. Where there are conflicts, the one or more processors of the electronic device configuration tool 210 can optionally prompt 622, at a user interface of the electronic device configuration tool 210, or alternatively at a user interface of the electronic device 111, for permission to store 621 the one or more changed user preferred electronic device settings from the electronic device 111, as well as how to handle conflicts, prior to storing the one or more changed user preferred electronic device settings from the electronic device 111.

In one or more embodiments, this storage step occurs only when the person requesting the storage is the authorized user 601 of the electronic device configuration tool 210. Accordingly, in one or more embodiments the authorized user 601 can deliver 623 subsequent authentication data 624 to a sensor of either the electronic device configuration tool 210 or the electronic device 111. In one or more embodiments, the subsequent authentication data 624 comprises fingerprint data delivered to a fingerprint sensor of the electronic device configuration tool 210. In another embodiment, the subsequent authentication data 624 comprises fingerprint data delivered to a fingerprint sensor of the electronic device 111, with the electronic device 111 then delivering the fingerprint data to the electronic device configuration tool 210.

An authentication device or one or more processors of the electronic device configuration tool 210 then compare 625 the subsequent authentication data 624 to one or more authentication references stored in an encrypted memory of the electronic device configuration tool 210 to determine whether the subsequent authentication data 624 sufficiently matches at least one authentication reference of the one or more authentication references so as to confirm that the authentication data was received from an authorized user 601 of the electronic device configuration tool 210. In one or more embodiments, the one or more processors of the electronic device configuration tool 210 only store 621 the one or more changed user preferred electronic device settings from the electronic device 111 when the subsequent authentication data 624 received by the authentication device of the electronic device configuration tool 210 belongs to the authorized user 601 of the electronic device configuration tool 210.

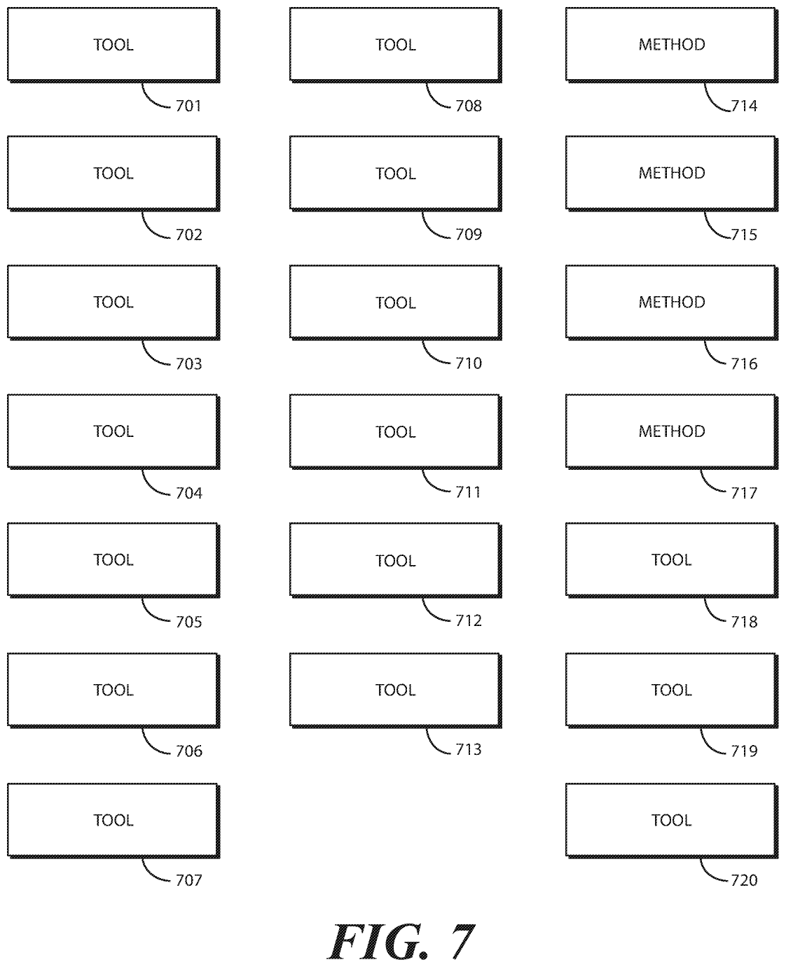

Turning now to FIG. 7, illustrated therein are various embodiments of the disclosure. 1. At 701, an electronic device configuration tool comprises a communication interface. At 701, the electronic device configuration tool comprises one or more processors electrically in communication with the communication interface. At 701, the electronic device configuration tool comprises an encrypted memory operable with the one or more processors. At 701, the encrypted memory stores a plurality of user preferred electronic device settings associated with a plurality of electronic device types.

At 701, the one or more processors detect the communication interface establishing electronic communication with another electronic device. At 701, the one or more processors identify an electronic device type of the other electronic device from signals received from the other electronic device through the communication interface.

At 701, the one or more processors select one or more user preferred electronic device settings applicable to the electronic device type of the another electronic device from the plurality of user preferred electronic device settings as a function of the electronic device type. At 701, the one or more processors automatically configure the other electronic device with the one or more user preferred electronic device settings by delivering one or more electronic device configuration signals to the other electronic device.

At 702, the one or more processors of 701 further receive user authentication data from the other electronic device through the communication interface. At 702, the one or more processors of 701 compare the user authentication data to one or more authentication references stored in the encrypted memory. At 702, the one or more processors of 701 automatically configure the another electronic device with the one or more user preferred electronic device settings only when the user authentication data sufficiently matches at least one authentication reference of the one or more authentication references so as to confirm the user authentication data was received from an authorized user of the electronic device configuration tool.

At 703, the user authentication data of 702 comprises biometric user authentication data. At 704, the electronic device configuration tool of 701 further comprises an authentication data receiver carried by the electronic device configuration tool and operable with the one or more processors.

At 705, the authentication data receiver of 704 receives user authentication data, and the one or more processors compare the user authentication data to one or more authentication references stored in the encrypted memory. At 705, the one or more processors automatically configure the other electronic device with the one or more user preferred electronic device settings only when the user authentication data sufficiently matches at least one authentication reference of the one or more authentication references so as to confirm the user authentication data was received from an authorized user of the electronic device configuration tool. At 706, the authentication data receiver of 705 comprises a fingerprint sensor.

At 707, the one or more user preferred electronic device settings of 701 enabling one or more functions of the other electronic device. 708, the one or more user preferred electronic device settings of 707 comprise an application suite for the other electronic device. At 709, the one or more user preferred electronic device settings of 707 comprise subscriber information module (SIM) data provisioning an embedded subscriber identification module (eSIM) of the other electronic device.

At 710, the encrypted memory of 707 further stores one or more authorization credentials allowing the other electronic device to access one or more services. At 710, the one or more processors automatically deliver the one or more authorization credentials to the communication interface. At 711, the one or more authorization credentials of 710 automatically cause a login event connecting the other electronic device to one or more cloud-based services across a network.

At 712, the one or more processors of 701 further detect cessation of the electronic communication with the other electronic device and, thereafter, reestablishment of the electronic communication with the other electronic device. At 712, upon detecting the reestablishment of the electronic communication with the other electronic device, the one or more processors query the other electronic device for changes to the one or more user preferred electronic device settings.

At 713, the one or more processors of 712 retrieve one or more changed user preferred electronic device settings from the other electronic device upon identifying the changes to the one or more user preferred electronic device settings. At 713, the one or more processors store the one or more changed user preferred electronic device settings in the encrypted memory.

At 714, a method of configuring an electronic device comprises detecting, with one or more processors of an electronic device configuration tool, electronic communication between the electronic device configuration tool and another electronic device. At 714, the method comprises identifying, with an authentication device operable with the one or more processors, whether authentication data received by the authentication device belongs to an authorized user of the electronic device configuration tool.

At 714, the method comprises determining, by the one or more processors from the electronic communication, a device type of the other electronic device. At 714, the method comprises selecting, by the one or more processors from an encrypted memory, one or more user preferred electronic device settings corresponding to the device type from a plurality of user preferred electronic device settings corresponding to a plurality of electronic device types. At 714, the method comprises delivering the one or more user preferred electronic device settings to the other electronic device only when the authentication data received by the authentication device belongs to an authorized user of the electronic device configuration tool.

At 715, the method of 714 further comprises detecting, by the one or more processors from the electronic communication, whether one or more changes have been applied to the one or more user preferred electronic device settings corresponding to the device type at the other electronic device. At 715, where the changes have been applied to the one or more user preferred electronic device settings corresponding to the device type at the another electronic device, the method comprises retrieving one or more changed user preferred electronic device settings from the another electronic device and storing the one or more changed user preferred electronic device settings in the encrypted memory.

At 716, the method of 715 further comprises identifying, with the authentication device, whether subsequent authentication data received by the authentication device belongs to the authorized user of the electronic device configuration tool. At 716, the storing the one or more changed user preferred electronic device settings from the another electronic device occurs only where the subsequent authentication data received by the authentication device belongs to the authorized user of the electronic device configuration tool. At 717, the method of 716 comprises the one or more processors causing a prompting, at a user interface of the another electronic device, for permission to store the one or more changed user preferred electronic device settings from the another electronic device prior to storing the one or more changed user preferred electronic device settings from the another electronic device.

At 718, an electronic device configuration tool comprises a communication interface. At 718, the electronic device configuration tool comprises one or more processors electrically in communication with the communication interface. At 718, the electronic device configuration tool comprises an encrypted memory operable with the one or more processors and storing a plurality of user preferred electronic device settings associated with a plurality of electronic devices.

At 718, the one or more processors detect the communication interface establishing electronic communication with another electronic device. At 718, the one or more processors identify whether the other electronic device is configured with any user preferred electronic device settings of the plurality of user preferred electronic device settings.

At 718, and where the one or more processors fail to identify the another electronic device being configured with the any user preferred electronic device settings of the plurality of user preferred electronic device settings, the one or more processors push one or more user preferred electronic device settings to the another electronic device through the communication interface. Alternatively, where the one or more processors identify the another electronic device being configured with the any user preferred electronic device settings of the plurality of user preferred electronic device settings, the one or more processors at 718 pull one or more changed user preferred electronic device settings from the other electronic device upon identifying the changes to the one or more user preferred electronic device settings and storing the one or more changed user preferred electronic device settings in the encrypted memory.

At 719, the electronic device configuration tool of 718 further comprises a biometric sensor operable with the one or more processors. At 719, the one or more processors push the one or more user preferred electronic device settings to the other electronic device through the communication interface only upon identifying data received from the biometric sensor as belonging to an authorized user of the electronic device configuration tool. At 720, the one or more processors of 718 further identify an electronic device type of the other electronic device from signals received from the other electronic device through the communication interface and select the one or more user preferred electronic device settings as a function of the electronic device type.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. An electronic device configuration tool, comprising:
a communication interface;
one or more processors electrically in communication with the communication interface; and
an encrypted memory operable with the one or more processors and storing a plurality of user preferred electronic device settings associated with a plurality of electronic device types;
the one or more processors:
detecting the communication interface establishing electronic communication with another electronic device;
identifying an electronic device type of the another electronic device from signals received from the another electronic device through the communication interface;
selecting one or more user preferred electronic device settings applicable to the electronic device type of the another electronic device from the plurality of user preferred electronic device settings as a function of the electronic device type; and
automatically configuring the another electronic device with the one or more user preferred electronic device settings by delivering one or more electronic device configuration signals to the another electronic device.

2. The electronic device configuration tool of claim 1, the one or more processors further receiving user authentication data from the another electronic device through the communication interface, comparing the user authentication data to one or more authentication references stored in the encrypted memory, and automatically configuring the another electronic device with the one or more user preferred electronic device settings only when the user authentication data sufficiently matches at least one authentication reference of the one or more authentication references so as to confirm the user authentication data was received from an authorized user of the electronic device configuration tool.

3. The electronic device configuration tool of claim 2, the user authentication data comprising biometric user authentication data.

4. The electronic device configuration tool of claim 1, further comprising an authentication data receiver carried by the electronic device configuration tool and operable with the one or more processors.

5. The electronic device configuration tool of claim 4, the authentication data receiver receiving user authentication data, and the one or more processors comparing the authentication data to one or more authentication references stored in the encrypted memory and automatically configuring the another electronic device with the one or more user preferred electronic device settings only when the authentication data sufficiently matches at least one authentication reference of the one or more authentication references so as to confirm the user authentication data was received from an authorized user of the electronic device configuration tool.

6. The electronic device configuration tool of claim 5, the authentication data receiver comprising a fingerprint sensor.

7. The electronic device configuration tool of claim 1, the one or more user preferred electronic device settings enabling one or more functions of the another electronic device.

8. The electronic device configuration tool of claim 7, the one or more user preferred electronic device settings comprising an application suite for the another electronic device.

9. The electronic device configuration tool of claim 7, the one or more user preferred electronic device settings comprising subscriber information module (SIM) data provisioning an embedded subscriber identification module (eSIM) of the another electronic device.

10. The electronic device configuration tool of claim 7, the encrypted memory further storing one or more authorization credentials allowing the another electronic device to access one or more services, the one or more processors automatically delivering the one or more authorization credentials to the communication interface.

11. The electronic device configuration tool of claim 10, the one or more authorization credentials automatically causing a login event connecting the another electronic device to one or more cloud-based services across a network.

12. The electronic device configuration tool of claim 1, the one or more processors further detecting cessation of the electronic communication with the another electronic device and, thereafter, reestablishment of the electronic communication with the another electronic device, and, upon detecting the reestablishment of the electronic communication with the another electronic device querying the another electronic device for changes to the one or more user preferred electronic device settings.

13. The electronic device configuration tool of claim 12, the one or more processors retrieving one or more changed user preferred electronic device settings from the another electronic device upon identifying the changes to the one or more user preferred electronic device settings and storing the one or more changed user preferred electronic device settings in the encrypted memory.

14. A method of configuring an electronic device, the method comprising:
detecting, with one or more processors of an electronic device configuration tool, electronic communication between the electronic device configuration tool and another electronic device;
identifying, with an authentication device operable with the one or more processors, whether authentication data received by the authentication device belongs to an authorized user of the electronic device configuration tool;
determining, by the one or more processors from the electronic communication, a device type of the another electronic device;
selecting, by the one or more processors from an encrypted memory, one or more user preferred electronic device settings corresponding to the device type from a plurality of user preferred electronic device settings corresponding to a plurality of electronic device types; and
delivering the one or more user preferred electronic device settings to the another electronic device only when the authentication data received by the authentication device belongs to an authorized user of the electronic device configuration tool.

15. The method of claim 14, further comprising detecting, by the one or more processors from the electronic communication, whether one or more changes have been applied to the one or more user preferred electronic device settings corresponding to the device type at the another electronic device, and, where the changes have been applied to the one or more user preferred electronic device settings corresponding to the device type at the another electronic device, retrieving one or more changed user preferred electronic device settings from the another electronic device and storing the one or more changed user preferred electronic device settings in the encrypted memory.

16. The method of claim 15, further comprising identifying, with the authentication device, whether subsequent authentication data received by the authentication device belongs to the authorized user of the electronic device configuration tool, the storing the one or more changed user preferred electronic device settings from the another electronic device occurring only where the subsequent authentication data received by the authentication device belongs to the authorized user of the electronic device configuration tool.

17. The method of claim 16, further comprising the one or more processors causing a prompting, at a user interface of the another electronic device, for permission to store the one or more changed user preferred electronic device settings from the another electronic device prior to storing the one or more changed user preferred electronic device settings from the another electronic device.

18. An electronic device configuration tool, comprising:
a communication interface;
one or more processors electrically in communication with the communication interface; and
an encrypted memory operable with the one or more processors and storing a plurality of user preferred electronic device settings associated with a plurality of electronic devices;
the one or more processors:
detecting the communication interface establishing electronic communication with another electronic device;
identifying whether the another electronic device is configured with any user preferred electronic device settings of the plurality of user preferred electronic device settings; and
where the one or more processors fail to identify the another electronic device being configured with the any user preferred electronic device settings of the plurality of user preferred electronic device settings, pushing one or more user preferred electronic device settings to the another electronic device through the communication interface; or
where the one or more processors identify the another electronic device being configured with the any user preferred electronic device settings of the plurality of user preferred electronic device settings, pulling one or more changed user preferred electronic device settings from the another electronic device upon identifying the changes to the one or more user preferred electronic device settings and storing the one or more changed user preferred electronic device settings in the encrypted memory.

19. The electronic device configuration tool of 18, further comprising a biometric sensor operable with the one or more processors, the one or more processors pushing the one or more user preferred electronic device settings to the another electronic device through the communication interface only upon identifying data received from the biometric sensor as belonging to an authorized user of the electronic device configuration tool.

20. The electronic device configuration tool of claim 18, the one or more processors further identifying an electronic device type of the another electronic device from signals received from the another electronic device through the communication interface and selecting the one or more user preferred electronic device settings as a function of the electronic device type.
